(19) United States
(12) Patent Application Publication
(10) Pub. No.: US 2023/0340235 A1
(43) Pub. Date: Oct. 26, 2023

(54) CORN-BASED PLASTICS REINFORCED BY LIGNIN AND CELLULOSE NANOFIBRILS

(71) Applicant: NDSU RESEARCH FOUNDATION, Fargo, ND (US)

(72) Inventors: Long Jiang, Fargo, ND (US); Yanlin Chen, Fargo, ND (US)

(21) Appl. No.: 18/306,553

(22) Filed: Apr. 25, 2023

Related U.S. Application Data
(60) Provisional application No. 63/363,520, filed on Apr. 25, 2022.

(51) Int. Cl. C08L 3/02

(52) U.S. Cl. CPC C08L 3/02

(57) ABSTRACT

The present disclosure relates to corn-based thermoplastic compositions. The disclosure describes improved mechanical properties and water resistance of the thermoplastics based on the incorporation of lignin and cellulose nanofibers into the plastics. The compositions disclosed herein can be used to make solid articles that possess a high degree of tensile strength and water resistance that are prepared, for example, by extrusion compounding and injection molding.

### CROSS-REFERENCE TO RELATED APPLICATIONS

This application claims priority under 35 U.S.C. § 119 to provisional application Ser. No. 63/363,520, filed Apr. 25, 2022, herein incorporated by reference in its entirety.

### TECHNICAL FIELD

The present disclosure relates to corn-based thermoplastic compositions. The disclosure describes improved mechanical properties and water resistance of the thermoplastics based on the incorporation of lignin and cellulose nanofibers into the plastics.

### BACKGROUND

In recent years, there has been an increased interest in producing renewable materials due to the significant environmental impacts of producing and disposing of petroleum-based polymers. Corn-derived materials including starch, zein, and polylactic acid (PLA) can be attractive materials for applications such as food packaging, mulch, plant pots, utensils, and other household and industrial items. Their potential to replace some petroleum-based polymers has been recognized and has been widely studied.

In its natural state, semi-crystalline starch exists in a granular form and shows poor processability. However, in the presence of plasticizers, the crystalline structure of starch granules can be ruptured under heat and shear due to the formation of the hydrogen bonds between the plasticizer and starch molecules. As a result, starch behaves like a typical thermoplastic polymer after this plasticization process, allowing the material (termed thermoplastic starch) to be processed in ways similar to conventional synthetic thermoplastic polymers. However, thermoplastic starch is rarely used alone because of its poor mechanical properties and low moisture resistance. Instead, it is often blended with hydrophobic thermoplastic polymers such as polyethylene, polypropylene, PLA, poly(ethylene-co-vinyl alcohol), or polyvinyl alcohol to improve its performance. Zein, the major storage protein of corn, can also be processed as a thermoplastic material in the presence of plasticizers. However, starch—zein blends exhibit poor mechanical properties because of the incompatibility between the two phases, resulting in poor stability of the resulting material.

### BRIEF SUMMARY OF PREFERRED EMBODIMENTS

An advantage of the disclosure is that it provides thermoplastic compositions, and articles prepared with the thermoplastic compositions, that comprise corn-based reinforcement materials. Most preferably, the corn-based reinforcement materials comprise lignin and cellulose nanofibrils. It is an advantage of the improved thermoplastic compositions that they are particularly suitable for injection molding, extrusion molding, 3D printing, and other methods of manufacturing articles comprising the improved thermoplastic compositions. Still a further advantage of the thermoplastic compositions disclosed herein is that they have many properties that are improved over thermoplastic materials prepared but without the reinforcements disclosed herein.

A preferred embodiment disclosed herein is a corn-based thermoplastic composition comprising from about 40 wt. % to about 80 wt. % of a corn-derived material comprising starch and zein; from about 0.1 wt. % to about 20 wt. % of a reinforcement material comprising cellulose nanofibrils, lignin, or a combination thereof; and from about 1 wt. % to about 50 wt. % of a plasticizer.

A preferred embodiment disclosed herein is an article comprised of a corn-based thermoplastic composition comprising from about 40 wt. % to about 80 wt. % of a corn-derived material comprising starch and zein; from about 0.1 wt. % to about 20 wt. % of a reinforcement material comprising cellulose nanofibrils, lignin, or a combination thereof; and from about 1 wt. % to about 50 wt. % of a plasticizer. In a preferred embodiment, the article can be manufactured by injection molding, extrusion molding, and/or 3D printing.

A preferred embodiment disclosed herein is a method of preparing a corn-based thermoplastic article, the method comprising combining a corn-derived material comprising starch and zein; a reinforcement material comprising cellulose nanofibrils, lignin, or a combination thereof; and a plasticizer to form a mixture, wherein the corn-derived material is present in an amount from about 40 wt. % to about 80 wt. %; wherein the reinforcement material is present in an amount from about 0.1 wt. % to about 20 wt. %; and wherein the plasticizer is present in an amount from about 1 wt. % to about 50 wt. %; and forming the mixture into the thermoplastic article.

While multiple embodiments are disclosed, still other embodiments of disclosure will become apparent to those skilled in the art from the following detailed description, which shows and describes illustrative, non-limiting embodiments of the disclosure. Accordingly, the figures and detailed description are to be regarded as illustrative in nature and not restrictive.

### BRIEF DESCRIPTION OF THE FIGURES

The following drawings form part of the specification and are included to further demonstrate certain embodiments or various aspects of the invention. In some instances, embodiments of the invention can be best understood by referring to the accompanying figures in combination with the detailed description presented herein. The description and accompanying figures may highlight a certain specific example, or a certain aspect of the invention. However, one skilled in the art will understand that portions of the example or aspect may be used in combination with other examples or aspects of the invention.

The patent or application file contains at least one drawing executed in color. Copies of this patent or patent application publication with color drawing(s) will be provided by the Office upon request and payment of the necessary fee.

FIG. 1. Flowchart of the corn-based thermoplastic sample preparation process. The photos on the top right corner of the figure shows the resin after internal mixing and hot press. The micrograph on the top left corner shows lignin powder.

FIG. 2. Tensile test results of the corn-based thermoplastics using a) ethylene glycol and b) glycerol as the plasticizers.

FIG. 3. Tensile test results of glycerol group composites.

FIG. 4. SEM micrographs of G(S)P-2 (a and b) and G(Z)P-2 composites (c, d, and e) taken under different magnifications. An color optical photograph of the cross section of G(Z)P-2 is shown in f. The circles in b and e indicate the lignin particles. The circle in d indicates the glycerol droplet.

FIG. 5. SEM micrographs of GC (a1, a2, & a3), GS-2 (b1, b2, & b3) and GP-2 (c1, c2, & c3) taken under different magnifications. Both composites were mixed in an internal mixer operating at 140° C. and 100 rpm for 15 min.

FIG. 6. SEM micrographs of GC-CNF4 (a1, a2, & a3) and GP-2-CNF4 (b1, b2, & b3) taken under different magnifications. Both composites were mixed in an internal mixer operating at 140° C. and 100 rpm for 15 min. Arrows indicate CNFs.

FIG. 7. SEM images showing the areas where the EDS analysis was conducted. (a) GC, (b) GS-2, and (c) GP-2. In every image, areas 1 and 2 represent the zein phase and areas 3 and 4 represent the starch phase.

FIG. 8. TGA and DTG curves for starch, zein, lignin, glycerol and ethylene glycol (a and b) and their composites (c and d).

FIG. 9. Flowchart of the starch-zein-based thermoplastic sample preparation process.

FIG. 10. Tensile test results of the corn-based thermoplastics based on starch/zein mixture.

FIG. 11. SEM micrographs of SZC (a1, a2, and a3), SZ-CNF6 (b1, b2, and b3), SZ-LP6 (c1, c2, and c3), SZ-LP6-CNF6 (d1, d2, and d3) taken under different magnifications.

FIG. 12. XRD patterns of the CNFs, SZC, SZ-LP6 and SZ-CNF6.

FIG. 13. Fourier transform infrared spectroscopy (FTIR) spectra of neat lignin, zein, starch and CNFs and their composites including SZC, SZ-LP6, SZ-CNF6 and SZ-LP6-CNF6.

FIG. 14. (a-b) TGA plot of starch, zein, lignin, glycerol and extruded composites. (c-d) weight loss derivative of starch, zein, lignin, glycerol and extruded composites.

FIG. 15. Flowchart of the cornmeal-based thermoplastic sample preparation process.

FIG. 16. Tensile test results of the corn-based thermoplastics based on cornmeal. Representative stress-strain curves for the samples are presented in FIG. A4 in the appendix.

FIG. 17. SEM micrographs of CMC (a1, a2, and a3) and CM-LP6-CNF6 (b1, b2, and b3) taken under different magnifications.

FIG. 18. Fourier transform infrared spectroscopy (FTIR) spectra of lignin, CNF, CMC and CM-LP6-CNF6.

FIG. 19. Comparison of the tensile properties of SZC and SZ-PEO15/G20.

FIG. 20. Tensile properties of CMC (140° C.), CM-PEO15/G20-CA0.5 (160° C.), CM-PEO15/G20-CA2 (160° C.), and CM-PEO15/G20-CA0.5 (140° C.).

### DETAILED DESCRIPTION

The present disclosure relates to corn-based thermoplastic compositions. The mechanical properties and water resistance of the thermoplastics were significantly improved by incorporating lignin and cellulose nanofibers into the plastics. The compositions may be used for making solid articles that possess a high degree of tensile strength and water resistance that are prepared, for example, by extrusion compounding and injection molding.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

The term “about,” as used herein, refers to variation in the numerical quantity that can occur, for example, through typical measuring techniques and equipment, with respect to any quantifiable variable, including, but not limited to, mass, volume, time, and temperature. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Corn-Based Thermoplastic Compositions

The present disclosure relates to corn-based thermoplastic compositions comprising a corn-derived material, a reinforcement material, and a plasticizer. The present compositions may be formed into solid articles of varying shapes, sizes and dimensions, that are useful in a variety of applications. Advantageously, products prepared with the composition display improved strength and water resistance over materials without the reinforcement material. The compositions may be formed into a solid article including, for example a tray, bottle, tubing, dishware such as a cup or a plate, flatware such as a spoon, knife, fork or other eating utensil, or other like articles, a packaging for another article or substance such as foods, drugs and the like. The compositions of the disclosure may also be molded or extruded to provide products such as packaging, loose fills, electronics enclosures, and the like.

The methods and compositions comprise a corn-derived material. In certain embodiments, the corn-derived material comprises starch and zein. Corn kernels contain mainly starch (about 62%), zein (about 7.8%), oil (about 3.8%), and ash (about 1.2%). Most of the corn starch is present in the endosperm, while most of the corn protein and oil are in the kernel germ. In certain embodiments, the corn-derived material is cornmeal. Cornmeal is a low-cost material containing both starch and zein. It is produced by directly grinding corn kernel into a powdered material. Cornmeal contains about 72.9% carbohydrate (of which about 84% is starch), about 9.85% protein (mainly zein), and about 5.88% fat.

The methods and compositions comprise a reinforcement material. In certain embodiments, the reinforcement material comprises cellulose nanofibrils, lignin, or a combination thereof. In certain embodiments, the reinforcement material comprises a combination of cellulose nanofibrils and lignin. Lignin can also function as a compatibilizer in the compositions to increase the compatibility between the starch and zein components. The cellulose nanofibrils and lignin act synergistically to improve the mechanical properties and water resistance of the compositions.

The methods and compositions comprise a plasticizer. Suitable plasticizers may include, for instance, polyhydric alcohols, such as sugars (e.g., glucose, sucrose, fructose, raffinose, maltodextrose, galactose, xylose, maltose, lactose, mannose, and erythrose), sugar alcohols (e.g., erythritol, xylitol, malitol, mannitol, and sorbitol), polyols (e.g., ethylene glycol, glycerol, propylene glycol, dipropylene glycol, butylene glycol, and hexane triol) and their polymers (e.g., polyethylene glycol, also known as polyethylene oxide (PEO) or polyoxyethylene (POE), polyvinyl alcohol, polyaziridines (e.g., polyethylenimine), polyoxazolines (e.g., poly (2-ethyl-2-oxazoline)), hyperbranched or dendritic polyols, polyamines, and hyperbranched or dendritic polyamines. Preferred plasticizers are polyols and their polymers. In certain embodiments, the plasticizer comprises glycerol, ethylene glycol, or polyethylene oxide.

The methods and compositions can comprise a thermal initiator. Exemplary thermal initiators include: azo compounds such as, for example, 2,2-azo-bisisobutyronitrile (AIBN), 2,2′-azobis(2-methylbutyronitrile), azo-2-cyanovaleric acid, dimethyl 2,2′-azobis(isobutyrate), azobis(diphenyl methane), 4,4′-azobis-(4-cyanopentanoic acid), (2,2′- azobis(2,4-dimethylvaleronitrile (available as VAZO™ 52); peroxides such as, for example, benzoyl peroxide, cumyl peroxide, tert-butyl peroxide, cyclohexanone peroxide, glutaric acid peroxide, and dilauryl peroxide; hydrogen peroxide; hydroperoxides such as, for example, tert butyl hydroperoxide, tert-amyl hydroperoxide, and cumene hydroperoxide; peracids such as, for example, peracetic acid and perbenzoic acid; potassium persulfate; and peresters such as, for example, diisopropyl percarbonate. In certain embodiments, the thermal initiator comprises a peroxide. The thermal initiator may be selected, for example, based on the temperature desired for use of the thermal initiator and compatibility with the curable composition. Combinations of two or more thermal initiators may also be useful.

The methods and compositions can comprise a processing aid. Suitable processing aid can include, for instance, organic acids, such as citric acid, lactic acid, acetic acid, formic acid, oxalic acid, uric acid, malic acid, or tartaric acid. In certain embodiments, the processing aid comprises citric acid. In certain embodiments, the compositions can include from about 1 wt. % to about 40 wt. % water to add moisture and facilitate processing of the compositions, or from about 5 wt. % to about 35wt. %, or from about 10 wt. % to about 30 wt. %. In a preferred embodiment, the processing aid is present in an amount from about 0.01 wt. % to about 10 wt. %, from about 0.05 wt. % to about 1 wt. %, or from about 0.1 wt. % to about 0.5 wt. %.

The compositions can further include additional additives as desired. Useful additives include, but are not limited to, a lubricating agent, coloring agent, preservatives, among others.

The composition may contain a minor but effective amount of a lubricating agent to provide a mold-or dye-lubricating effect when the composition is molded into the desired article, for example, by aiding in the release of the molded article from the mold. Water-insoluble lubricants may also increase the water-resistance of the products. Examples of suitable lubricants that may be used in the compositions, either alone or in combination with another lubricant, include soybean oil, phospholipids such as lecithin, mono- and diglycerides, and fatty acids, preferably saturated fatty acids; vegetable oil, preferably hydrogenated forms, phosphoric acid-derivatives of the esters of polyhydroxy compounds, animal lipids, preferably hydrogenated forms to prevent thermal oxidation, petroleum silicone and mineral oils, and the like. In certain embodiments, the amount of lubricant included in the composition is from about 0.1 to about 2 wt. % or from about 0.5 to about 1.5 wt. %.

A compatible antimicrobial agent such as a fungicide or bactericide can also be included in the composition in an amount effective to prevent growth of fungi, bacteria and the like, in or on the compositions or an article formed from the compositions. Examples of useful preservatives include sodium salts of propionic or sorbic acid, sodium diacetate, parabens, vinegar, monocalcium phosphate, lactic acid, and the like, and mixtures thereof. The composition can include from about 0.05 to about 0.3 wt. % preserving agent.

The compositions can further include a coloring agent as desired. Coloring agents, suitable for use in the present compositions include, for example, azo dyes such as Bismarck Brown 2R and Direct Green B; natural coloring agents such as chlorophyll, xanthophyll, carotene, and indigo; and metallic oxides such as iron or titanium oxides. The coloring agent can be included in the composition at a concentration of about 0.01 to about 10 wt. %, preferably about 0.5 to about 3 wt. %.

### Preparation of Compositions and Formed Articles

The composition ingredients are mixed and exposed to heat to cure the composition. In some embodiments, the compositions are formed into a desired article according to conventional processing techniques known in the art for preparing molded plastic articles. In some embodiments, the articles can be formed by 3D printing.

The mixing system may be a continuous flow mixer such as a Teledyne continuous processor or a Beardsley Piper continuous mixer, and the like, or more preferably, a twin screw extruder apparatus, with a twin-screw extruder being highly preferred, as for example, a multiple section Buhler Miag twin screw extruder, a Brabender type PL 2000 extruder, a Leistritz type ZSE 40 MAXX extruder, and the like. The ingredients are mixed together at high shear to form a substantially homogeneous consistency with the ingredients distributed substantially evenly throughout.

For example, the ingredients may be processed in an extruder by feeding the ingredients into the barrel of the extruder, mixing the ingredients to a plasticized consistency, extruding the mixture through a discharge port or die, and then sectioning the extrudate into pieces. In certain embodiments, the ingredients are processed in a twin-screw extruder which has multiple barrel sections with means for mixing the ingredients with varying temperature, pressure and shear, and screws for shearing and conveying the mixture through the extruder to the discharge port. The extrusion conditions, for example, the screw configuration, elements, pitch and speed, the barrel configuration, temperature and pressure, the shear and throughput rate of the mixture, the die hole diameter, feed rate of the ingredients, and other conditions, may be varied in each barrel section as desired to achieve effective mixing of the ingredients to form a substantially homogeneous semi-solid mixture in which the ingredients are distributed evenly throughout.

In the extruder, the action of the rotating screw or screws will mix the ingredients and force the mixture through the sections of the extruder with considerable pressure. A useful extruder for processing the corn-based composition is a Leistritz type ZSE 40 MAXX extruder which has ten heating zones (barrel sections) in which heat can be applied to the ingredient mixture. Some barrel sections are equipped with vacuum ports to remove volatiles from the material (e.g. moisture and gaseous reaction byproducts) and side feed ports to inject more ingredients into the material during the extrusion process. The amount of heat applied is suitable for thorough mixing and reaction of the ingredients. The plastic composition is extruded through the discharge port or die into air or other gaseous medium. The extrudate is then sectioned into pellets of desired size, dried, and either stored for use at a later time or used in an injection molding process to form a biodegradable plastic product. The extruded mixture solidifies within a few minutes, depending, for example, on the size of the extruded portion, the ingredients of the composition, the temperature of the composition, and other like factors.

After mixing, the mixture is discharged from the mixing system, and either directly used in a molding system (i.e., injection molding), or allowed to adjust the moisture content for later use. The discharged material (i.e., extrudate) may be sectioned into pellets or other small pieces, and dried. The material may be processed into a solid article, for example, by injection molding process wherein an amount of the plastic composition in melted form is forced into a mold and maintained under pressure until cool; by compression molding wherein direct pressure is applied using a hydraulic press on an amount of the composition contained in a cavity; by blow molding wherein a tube of the thermoplastic composition is extruded into a mold and air pressure is applied to the inside of the tube to conform it to the mold and form a hollow article; and by other methods such as, transfer molding, vacuum forming, pressure forming, and inflation molding, or other suitable molding technique.

### Embodiments

The following numbered embodiments also form part of the present disclosure:
1. A corn-based thermoplastic composition comprising: a corn-derived material comprising starch and zein; a reinforcement material comprising cellulose nanofibrils, lignin, or a combination thereof; and a plasticizer.
2. The composition of embodiment 1, wherein the corn-derived material comprises cornmeal.
3. The composition of embodiment 1, wherein the starch and zein are present in a ratio of about 1:1 to about 8:1; more preferably about 3:1 to about 8:1; most preferably about 3:1 to about 5:1.
4. The composition of any one of embodiments 1-3, wherein the corn-derived material is present in an amount from about 40 wt. % to about 80 wt. %.
5. The composition of any one of embodiments 1-4, wherein the reinforcement material comprises the combination of cellulose nanofibrils and lignin.
6. The composition of any one of embodiments 1-5, wherein the reinforcement material is present in an amount from about 0.1 wt. % to about 20 wt. %, from about 0.5 wt. % to about 15 wt. %, or from about 1 wt. % to about 10 wt. %.
7. The composition of any one of embodiments 1-6, wherein the plasticizer comprises glycerol, ethylene glycol, or polyethylene oxide.
8. The composition of any one of embodiments 1-7, wherein the plasticizer is present in an amount from about 1 wt. % to about 50 wt. %, from about 5 wt. % to about 40 wt. %, from about 15 wt. % to about 35 wt. %, or from about 20 wt. % to about 30 wt. %.
9. The composition of any one of embodiments 1-8, further comprising a processing aid.
10. The composition of embodiment 9, wherein the processing aid comprises an organic acid, optionally wherein the organic acid is citric acid.
11. The composition of embodiment 9 or embodiment 10, wherein the processing aid is present in an amount from about 0.01 wt. % to about 10 wt. %, from about 0.05 wt. % to about 1 wt. %, or from about 0.1 wt. % to about 0.5 wt. %.
12. The composition of any one of embodiments 1-11, further comprising a thermal initiator, optionally wherein the thermal initiator comprises a peroxide.
13. The composition of any one of embodiments 1-12, further comprising one of more additives.
14. A solid article formed from the composition of any one of embodiments 1-13.
15. The article of embodiment 14, wherein the modulus of the article is at least about 50 MPa, at least about 75 MPa, at least about 100 MPa, at least about 125 MPa, at least about 150 MPa, at least about 175 MPa, at least about 200 MPa, or at least about 225 MPa.
16. The article of embodiment 14 or embodiment 15, wherein the modulus of the article is increased by at least about 100%, at least about 200%, at least about 300%, at least about 400%, at least about 500%, at least about 600%, at least about 700%, at least about 700%, at least about 800%, at least about 900%, at least about 1000%, at least about 1100%, at least about 1200%, or at least about 1300% relative to a control article formed from a composition without the reinforcement material.
17. The article of any one of embodiments 14-16, wherein the strength of the article is at least about 5 MPa, at least about 10 MPa, at least about 15 MPa, or at least about 20 MPa.
18. The article of any one of embodiments 14-17, wherein the strength of the article is increased by at least about 50%, at least about 100%, at least about 150%, at least about 200%, at least about 250%, at least about 300%, or at least about 350% relative to a control article formed from a composition without the reinforcement material.
19. The article of any one of embodiments 14-18, wherein the article is formed by injection molding, extrusion molding, or 3D printing.
20. A method of preparing a corn-based thermoplastic article, the method comprising: combining a corn-derived material comprising starch and zein; a reinforcement material comprising cellulose nanofibrils, lignin, or a combination thereof; and a plasticizer to form a mixture, and forming the mixture into the thermoplastic article.
21. The method of embodiment 20, wherein the corn-derived material comprises cornmeal.
22. The method of embodiment 20, wherein the starch and zein are present in a ratio of about 1:1 to about 8:1; more preferably about 3:1 to about 8:1; most preferably about 3:1 to about 5:1.
23. The method of any one of embodiments 20-22, wherein the corn-derived material is present in an amount from about 40 wt. % to about 80 wt. %.
24. The method of any one of embodiments 20-23, wherein the reinforcement material comprises the combination of cellulose nanofibrils and lignin.
25. The method of any one of embodiments 20-24, wherein the reinforcement material is present in an amount from about 0.1 wt. % to about 20 wt. %, from about 0.5 wt. % to about 15 wt. %, or from about 1 wt. % to about 10 wt. %.
26. The method of any one of embodiments 20-25, wherein the plasticizer comprises glycerol, ethylene glycol, or polyethylene oxide.
27. The method of any one of embodiments 20-26, wherein the plasticizer is present in an amount from about 1 wt. % to about 50 wt. %, from about 5 wt. % to about 40 wt. %, from about 15 wt. % to about 35 wt. %, or from about 20 wt. % to about 30 wt. %.
28. The method of any one of embodiments 20-27, further comprising a processing aid.
29. The method of embodiment 28, wherein the processing aid comprises an organic acid, optionally wherein the organic acid is citric acid.
30. The method of embodiment 28 or embodiment 29, wherein the processing aid is present in an amount from about 0.01 wt. % to about 5 wt. %, from about 0.05 wt. % to about 1 wt. %, or from about 0.1 wt. % to about 0.5 wt. %.
31. The method of any one of embodiments 20-30, further comprising a thermal initiator, optionally wherein the thermal initiator comprises a peroxide.
32. The method of any one of embodiments 20-31, further comprising one of more additives.
33. The method of any one of embodiments 20-32, wherein the forming is by injection molding, extrusion molding, or 3D printing.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

The following examples are offered by way of illustration and not by way of limitation.

### EXAMPLES

### Example 1

### Improving Mechanical Properties of Thermoplastic Starch-Zein Composites through Incorporating Kraft Lignin and Cellulose Nanofibers

This Example describes the development of a corn-based thermoplastic with substantially improved mechanical properties and water resistance than traditional thermoplastic starch plastic. The main components of corn, i.e., starch and zein, are incompatible but offer complementary properties—hydrophobic zein increases water resistance of thermoplastic starch. The incorporation of amphiphilic and functional lignin and CNFs improves the compatibility, refines the zein/starch phase structure, and therefore increases the mechanical properties of the new corn thermoplastic.

### Materials

Argo® pure corn starch was purchased from a local grocery store. Zein (W555025) and Kraft lignin (471003) were both purchased from Sigma-Aldrich. The zein had a protein concentration of ˜92% and an ash content of <2%. The lignin contained 4% sulfur and had an average Mw of ˜10,000. Glycerol (99+%, 11443297) and ethylene glycol (BDH1125-1LP) were purchased from Alfa Aesar and VWR, respectively. CNF slurry with a CNF concentration of ˜2.5 wt % was purchased from the Process Development Plant of University of Maine. The slurry was concentrated by centrifugation to increase the concentration to 10 wt % before use. All the chemicals and materials were used as received without further purification or modification.

### Methods

### Lignin Solution Preparation

Glycerol and ethylene glycol were used as the plasticizers in the corn-based thermoplastic in this Example. Lignin was incorporated into the material in the form of either dry powder or solutions (in glycerol or ethylene glycol). To prepare the solutions, glycerol or ethylene glycol were first mixed with distilled water at a 1:1 weight ratio. Predetermined amounts of lignin powder were then added into the mixtures to obtain lignin/glycerol/water ratios of x/50/50 (w/w/w, x=0, 1, 2). Complete lignin dissolution was achieved after stirring the mixtures (500 rpm) for one hour under room temperature. The obtained lignin solutions were stored under ambient conditions for future use and testing. Four lignin solutions were prepared in total and their compositions and sample codes are listed in Table 1.

TABLE 1

| Sample | Ingredients (All in parts) | | | |
|---|---|---|---|---|
| Codes | Lignin | Glycerol | Ethylene Glycol | Distilled Water |
| EG-1 | 1 | 0 | 50 | 50 |
| EG-2 | 2 | 0 | 50 | 50 |
| G-1 | 1 | 50 | 0 | 50 |
| G-2 | 2 | 50 | 0 | 50 |

### Preparation of Thermoplastic Starch-Zein Composites

When lignin was incorporated into the composites in the form of dry powder, 80 parts of corn starch, 20 parts of zein and x parts of lignin powder (x=0, 1, 2) were manually mixed in a beaker to achieve an even distribution. Glycerol/water (50 parts/50 parts) or ethylene glycol/water (50/50) as the plasticizer was added to the premixed powder, manually mixed, and then sealed in a plastic bag and stored for 24 hours to achieve equilibrium. The mixture was compounded into a thermoplastic using a HAKKE internal mixer (Rheomix 600 Haake, Germany) operating at 140° C. and 100 rpm. The product was compressed into ˜0.5 mm thickness sheets using a hot press (1200 N, 10 min) and cut into standard tensile test specimens for mechanical property characterization. When lignin solutions were used, the liquids were mixed with the corn starch and zein powder in the beaker and a reduced amount of plasticizer was added to maintain a constant content of the plasticizer. To prepare the composites containing CNFs, the concentrated nanofiber slurry was first dispersed in the plasticizer solutions through sonication. The premixed starch/zein/lignin powder was slowly added to the solutions under continuous stirring, and the mixture was sealed in a plastic bag for 24 h before compounding.

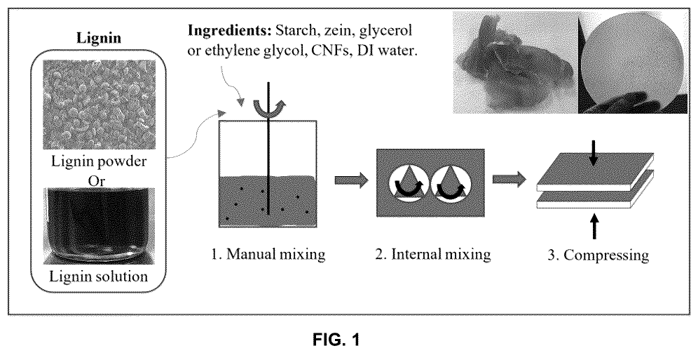

A flow chart of the sample preparation process is shown in FIG. 1. All the prepared samples are listed in Table 2 with their sample codes and respective compositions. In the sample codes, G and EG denote the glycerol and ethylene glycol plasticizers, respectively. P and S denote the lignin in powder and solution forms, respectively. The number after the dash indicates the part number of the lignin. CNF and the number after it indicate the presence of CNFs in the composites and its part number. For instance, GP-2-CNF4 means that the composite contains 2 parts lignin powder and 4 parts CNF and has glycerol as the plasticizer. Letter C in the sample codes indicates the denoted samples are control samples, containing no lignin and CNFs.

TABLE 2

| | Ingredients (All in parts) | | | | | | |
|---|---|---|---|---|---|---|---|
| Sample | Corn | | | Cellulose | | Ethylene | Distill |
| Codes | Starch | Zein | Lignin | Nanofiber | Glycerol | Glycol | Water |
| EGC | 80 | 20 | 0 | 0 | / | 50 | 50 |
| EGP-1 | 80 | 20 | 1 | 0 | / | 50 | 50 |
| EGP-2 | 80 | 20 | 2 | 0 | / | 50 | 50 |
| EGS-1 | 80 | 20 | 1 | 0 | / | 50 | 50 |
| EGS-2 | 80 | 20 | 2 | 0 | / | 50 | 50 |
| GC | 80 | 20 | 0 | 0 | 50 | / | 50 |
| GP-1 | 80 | 20 | 1 | 0 | 50 | / | 50 |
| GP-2 | 80 | 20 | 2 | 0 | 50 | / | 50 |
| GS-1 | 80 | 20 | 1 | 0 | 50 | / | 50 |
| GS-2 | 80 | 20 | 2 | 0 | 50 | / | 50 |
| G(S)P-2* | 100 | 0 | 2 | 0 | 50 | / | 50 |
| G(Z)P-2* | 0 | 100 | 2 | 0 | 50 | / | 50 |
| GP-2-CNF2 | 80 | 20 | 2 | 2 | 50 | / | 50 |
| GP-2-CNF4 | 80 | 20 | 2 | 4 | 50 | / | 50 |
| GP-2-CNF6 | 80 | 20 | 2 | 6 | 50 | / | 50 |
| GC-CNF2 | 80 | 20 | 0 | 2 | 50 | / | 50 |
| GC-CNF4 | 80 | 20 | 0 | 4 | 50 | / | 50 |
| GC-CNF6 | 80 | 20 | 0 | 6 | 50 | / | 50 |

### Sample Characterization

Dynamic light scattering (DLS) (Nicomp 380, Particle Sizing Systems, Santa Barbara, CA, USA) was used to characterize the particle size of lignin in glycerol or ethylene glycol solutions. The tests were carried out at 20° C. using the following parameters: 5.922 cP and 2.800 cP for the viscosities of the glycerol and ethylene glycol solutions, respectively, and 1.398 and 1.383 for their refractive indexes. Three repeats were tested to obtain the average particle sizes.

Tensile properties of the composites were characterized using the dumbbell test bars cut from the hot-pressed sheets. The tests were performed under ambient conditions (−23° C.) on an MTS Insight test system equipped with a 5 kN electronic load cell at a crosshead speed of 50 mm/min.

Scanning electron microscopy (SEM) was used to study the morphology of lignin powder and the microstructure of the composites. Lignin powder sample was placed on carbon adhesive tabs on aluminum mounts and the excess material was blown off with a forceful stream of dry nitrogen gas. Composites samples were cooled in liquid nitrogen and fractured. The fractured samples were attached to aluminum mounts with silver paint to view the fracture surfaces. The surfaces were coated with conductive carbon using a Cressington 208c carbon coater (Ted Pella Inc., Redding, California) before imaging. Images were obtained with a JEOL JSM-7600F scanning electron microscope (JEOL USA Inc., Peabody, Massachusetts) operating at 2 kV. Energy dispersive spectroscopy (EDS) was used to determine the elemental concentrations of sulfur and sodium in the different phases of the composites. The two elements were brought into the composites through lignin and their distributions could be used to determine the distribution of the lignin in the composites. EDS information was acquired at an accelerating voltage of 8 kV using an UltraDry silicon drift X-ray detector and NSS-212e NORAN System 7 X-ray Microanalysis System (Thermo Fisher Scientific, Madison, Wisconsin).

Thermogravimetric analysis (TGA, TA Instruments Q500) was performed to determine the thermal stability of the composites and the constituents. All sample were tested between room temperature and 600° C. with a heating rate of 10° C./min under a continuous air flow (60 ml/min).

### Results and Discussion

### Lignin Particle Size in Solution

Table 3 shows lignin particle size and size distribution in glycerol/water (G) (1:1) and ethylene glycol/water (EG) (1:1) solutions. Two parts of lignin were dissolved in each sample. Most of the lignin particles (>98%) had a particle size of ˜7.27 nm in the glycerol solution and ˜6.10 nm in the ethylene glycol. The particle sizes increased (roughly doubled) after additional 24 h storage. In term of ease of dissolution, the kraft lignin was water soluble and could be dissolved in water within half of an hour. It took about one hour to dissolve the same amount of lignin in pure ethylene glycol and about 5 days in pure glycerol. Since the polarity of glycerol is higher than that of ethylene glycol, the slow dissolution in glycerol may be attributed to glycerol's much higher viscosity than ethylene glycol (5.9 cP vs 2.8 cP), which makes the diffusion of the solvent much slower. This higher viscosity can also contribute to the larger lignin particle size in glycerol. The increases in the particle sizes with increasing storage time is due to weak electrostatic repulsion between the lignin particles. The impurities in lignin solution could further speed up the formation and growth of aggregates.

TABLE 3

| Sample | Storage time | Peak 1 (nm/%) | Peak 2 (nm/%) | Peak 3 (nm/%) |
|---|---|---|---|---|
| G-2 | 24 h | 7.27/99.30 | 79.6/0.50 | 406.1/0.20 |
| G-2 | 72 h | 14.6/97.60 | 180.7/1.20 | 594.3/1.90 |
| EG-2 | 24 h | 6.1/98.7 | 26.9/1.20 | 371.8/0.10 |
| EG-2 | 72 h | 11/98.50 | 101.1/8.30 | 725.8/0.70 |

### Tensile Properties

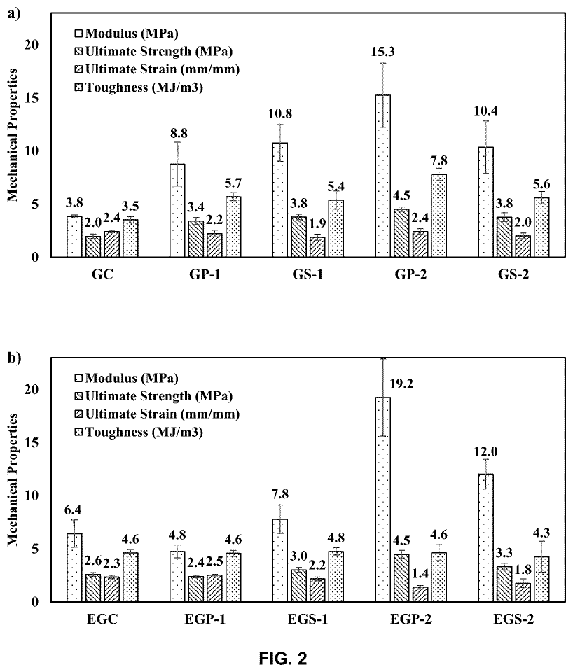

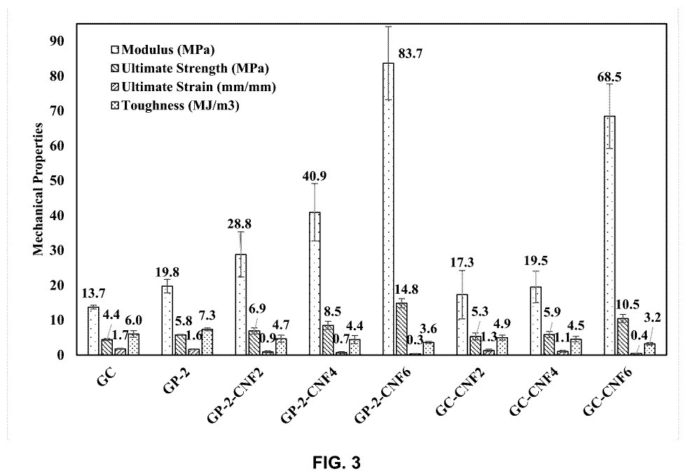

Tensile test results for all the formulations listed in Table 2 are compared in FIG. 2 and FIG. 3. FIG. 2A compares the results from the samples using ethylene glycol as the plasticizer while FIG. 2B compares those using glycerol. For the first system (FIG. 2A), in general the strength and modulus of the samples increased with the content of the lignin, regardless of being incorporated in the form of powder or solution. While the strength and modulus being improved, the ultimate (fracture) strain and toughness of the samples were generally decreased as the samples became increasingly rigid. The lignin incorporated in powder form at two parts led to the best overall mechanical properties among all the formulations.

For the glycerol system (FIG. 2B), a similar property trend was observed: a higher lignin content led to higher mechanical properties for both lignin forms. It was still the powder lignin at 2 parts that produced the highest overall composite properties. Specifically, in the glycerol system the modulus and strength of the control sample (GC) were increased by 297.3% and 129.5% respectively after two parts of powder lignin was incorporated, whereas in the ethylene glycol system the increases were much smaller at 198.8% and 72.7%, respectively. The percentage changes of the properties for all the composites are summarized in Table 4.

Table 4 shows that lignin offered stronger reinforcement in the glycerol system than in the ethylene glycol system based on the percentage increases in the sample modulus and strength. Moreover, significant increases in toughness were simultaneously incurred by the lignin in the glycerol system, whereas in the ethylene glycol system the toughness was similar or even slightly decreased. The results in Table 4 do not suggest any clear advantages of using lignin solutions over lignin powder. Since the as-received lignin powder can dissolve in the water/plasticizer mixture (during the formulation and equilibrium stage and the internal mixer blending process), pre-dissolving the lignin powder before formulation appears unnecessary for achieving homogeneous dispersion of the lignin. Indeed, for both ethylene glycol and glycerol systems, the formulations containing two parts of powder lignin showed the best overall mechanical properties.

TABLE 4

| | Modulus | Ultimate Strength | Ultimate Strain | Toughness |
|---|---|---|---|---|
| GC | 0.0% | 0.0% | 0.0% | 0.0% |
| GP-1 | 128.3% | 73.5% | −7.9% | 61.9% |
| GS-1 | 180.2% | 92.8% | −22.7% | 52.6% |
| GP-2 | 297.3% | 129.5% | 0.1% | 121.3% |
| GS-2 | 170.0% | 92.1% | −17.0% | 59.2% |
| EGC | 0.0% | 0.0% | 0.0% | 0.0% |
| EGP-1 | −26.1% | −7.6% | 7.5% | −1.0% |
| EGS-1 | 20.9% | 17.1% | −7.4% | 2.9% |
| EGP-2 | 198.8% | 72.7% | −41.1% | 0.2% |
| EGS-2 | 86.9% | 28.7% | −25.0% | −7.8% |

It is also worth noting that the control samples of both systems, i.e., EGC and GC, showed markedly different properties. EGC exhibited a higher modulus and strength but a lower ultimate strain than GC. The viscosity of ethylene glycol was about half of that of glycerol and the former was expected to show a stronger plasticizing effect than the latter, leading to a lower composite modulus and strength. The unexpected high modulus and strength of EGC is believed to be caused by the much lower boiling point of ethylene glycol compared to glycerol (197° C. vs 290° C.). The incorporation of lignin further reduced the boiling temperature of ethylene glycol to around 160° C., which was caused by reduced hydrogen bonding between ethylene glycol molecules after the addition of lignin. It was noticed during the melt blending process that steam (due to volatilization of water and the plasticizers) was released from the internal mixer. With a lower boiling point, the loss of ethylene glycol is expected to be heavier than that of glycerol, resulting in less residual plasticizer in the composites and hence more rigid materials.

Based on the above discussion, GP-2 was selected for further reinforcement using CNFs. FIG. 3 compares the mechanical properties of GP-2 after incorporating 2, 4, or 6 parts of CNFs. The results for the composites containing CNFs but no lignin, i.e. GC-CNF2, GC-CNF4, and GC-CNF6, are also shown for comparison. First, the reinforcement effect of the CNFs in the last three composites could be clearly observed. Especially, at 6 parts of CNFs, the modulus and strength of the composite were 5 and 2.4 times, respectively, those of the control sample GC. The reinforcement of CNFs to polymer matrixes is well known and have been observed in many polymer nanocomposites. Second, when comparing these three composites with the composites containing both CNFs and lignin, i.e. GP-2-CNF2, GP-2-CNF4, and GP-2-CNF6, the latter exhibited significantly higher modulus and strength than the former at the same CNF contents, as shown in both FIG. 3 and Table 5. This result clearly showed the synergy between the lignin and CNFs in reinforcing the corn-based plastics. It should also be pointed out that the composites containing CNFs exhibited reduced toughness compared to the control sample (GC) and the sample containing only lignin (GP-2), as shown in Table 5. This is likely due to the constrained mobility of the polymer chains, which is caused by the interactions between CNFs and the matrix polymers.

TABLE 5

| | | Ultimate | Ultimate | |
|---|---|---|---|---|
| | Modulus | Strength | Strain | Toughness |
| GC | 0.0% | 0.0% | 0.0% | 0.0% |
| GP-2 | 44.1% | 30.7% | −6.7% | 22.1% |
| GP-2-CNF2 | 110.2% | 56.3% | −48.0% | −22.5% |
| GP-2-CNF4 | 198.3% | 92.4% | −59.5% | −26.9% |
| GP-2-CNF6 | 510.1% | 236.4% | −80.4% | −40.5% |
| GC-CNF2 | 26.2% | 19.9% | −26.3% | −18.0% |
| GC-CNF4 | 42.1% | 33.0% | −39.0% | −24.9% |
| GC-CNF6 | 399.4% | 137.0% | −76.4% | −46.8% |

### SEM Analysis

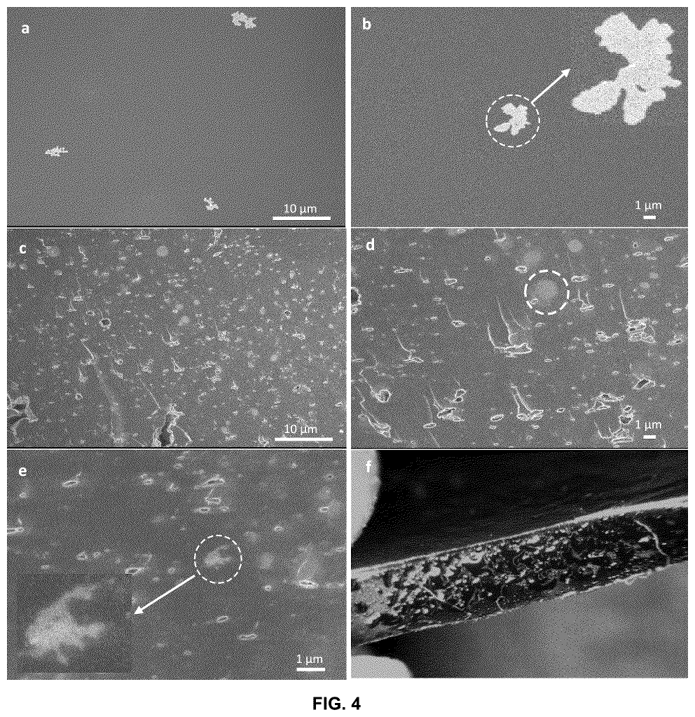

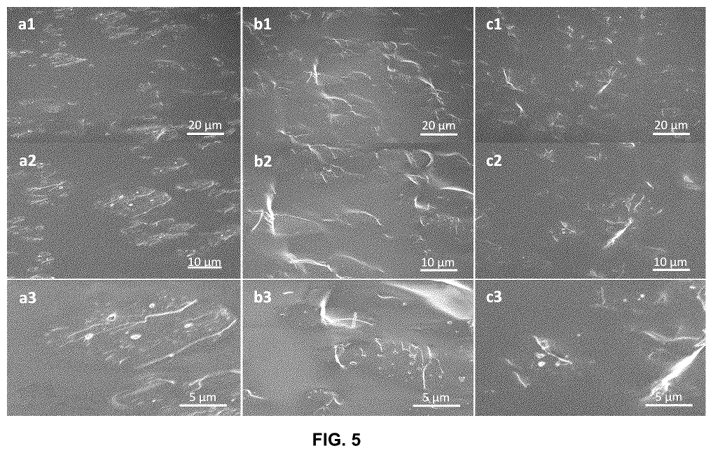

The microstructure of the composites was studied using SEM and the results were correlated to their mechanical properties. FIG. 4 shows the cross-sections of the G(S)P-2 (containing starch and 2 parts powder lignin) and G(Z)P-2 (containing zein and 2 parts powder lignin) composites. They are shown and discussed first to lay the foundation for the discussion about the composites containing both starch and zein. G(S)P-2 showed a very smooth cross-section and lignin particles between 0.5-4 μm could be clearly observed on the facture surface (FIG. 4A-B). During internal mixing, starch granules were destructed by the mechanical forces with the assistance of plasticizer and heat, and the material appeared and flew like a molten thermoplastic. This led to a homogeneous thermoplastic starch product as shown in the figure.

By contrast, the cross-section of G(Z)P-2 was not as smooth because it contained many cavities (FIG. 4C-E). These cavities were formed by trapped air during the internal mixing. It was observed that during the mixing G(Z)P-2 formed a porous, paste-like material which contained insufficiently plasticized zein aggregates. These aggregates imparted high resistance to material flow during the mixing and resulted in a much higher mixing torque of G(Z)P-2 than G(S)P-2 (22.8 Nm vs 7 Nm). Many of the pores in the mixed material were transformed into the cavities shown in the micrographs after the material was compressed into a sheet. The insufficient plasticization of zein in the presence of glycerol may be ascribed to the incompatibility of the two materials. The incompatibility led to separation of glycerol from the zein matrix, which resulted in the presence of the spheres (i.e. glycerol droplets) shown in FIG. 4D. Glycerol can also be observed from the optical photograph shown in FIG. 4F, where the liquid plasticizer leached out from the matrix and adhered to the facture surface. The presence of the cavities and glycerol droplets made the identification and size determination of the lignin particles difficult. Nevertheless, it can be estimated from comparing FIG. 4D-E that the average particle size of the lignin in zein was smaller than that in starch. The lignin particles in the two composites were estimated to vary between 0.5-4μm. Stevens et al. found the size of lignin in starch/Kraft lignin/glycerol blends was 0.1 to 1 μm. which is similar to our findings.

FIG. 5 shows SEM images of the cross-sections of the composites containing both starch and zein. In the control sample GC (FIG. 5A), a typical sea-island phase structure could be identified with the sea and island being the starch and zein phases, respectively. The interface between the two phases was obvious. The incorporation of the solution lignin led to a smaller domain size of zein in GS-2 (FIG. 5B) and the incorporation of the powder lignin produced the most refined phase structure in GP-2 among the three composites (FIG. 5C). GP-2 exhibited the smallest domain size of zein and the least distinguishable interface between the starch and zein phases. This evolution of the composite phase structure indicates improved compatibility and strengthened interfacial bonding between the two phases after the incorporation of the lignin, which, based on the composite mechanics theory, contributed to the increases in mechanical properties of the composites containing lignin. It is also worth noting that cavities were still present in the zein phase of the composites. The strong compatibility between glycerol and starch suggests that most of the plasticizer would be distributed in the starch phase in the composites containing both starch and zein.

The reduced domain size of zein and the more compatible interface can be attributed to two possible reasons. One is the increased shear stress during internal mixing. It was observed that the mixing torque was higher for the formulations containing lignin. The higher torque was due to the higher shear stress that was applied on the lignin-containing formulations during mixing. The higher stress promoted breakup of the dispersed zein domains and let to refined phase structure. The second reason is due to the multifunctional lignin, which contains groups including hydroxyl, methoxyl, carbonyl, and carboxyl groups. These groups can interact with the functional groups on starch and zein physically or chemically, and therefore compatibilize the two phases to a certain degree. The nano/micro-sized lignin particles dispersed at the starch/zein interface can increase interfacial adhesion between the two phases and therefore hinders agglomeration of the zein domains.

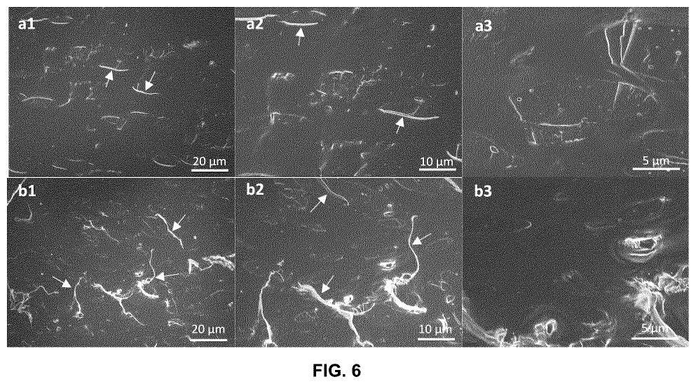

FIG. 6 compares the morphology of two composites containing cellulose nanofibrils. GC-CNF4 contained starch, zein, and four parts CNF whereas GP-2-CNF4 contained additional two parts lignin powder. Besides the sea-island structure, some new observations can be made from these two composites. First, GP-2-CNF4 composite has the smallest zein domain size among the GP-2, GC-CNF4 and GP-2-CNF4 samples. The further reduction in the domain size after the incorporation of CNFs can be ascribed to the increased shear stress in the samples containing CNFs. The mixing torques for GP-2, GC-CNF4 and GP-2-CNF4 were 6 Nm, 9 Nm, and 11 Nm, respectively, indicating the increased shear stress after the CNF incorporation.

Second, comparing GC (FIG. 5A) with GC-CNF4 (FIG. 6A), the latter showed more distinguishable edges of the zein domains. At the edges of some of the domains, ribbon-like objects, which were hypothesized to be CNF bundles, were pulled out from the surface. In GP-2-CNF4 (FIG. 6B), CNF bundles could be seen in larger numbers and longer lengths on the surface. The exact reason for this enhanced visibility of CNFs is still unknown, but we hypothesize that it is related to the added lignin in GP-2-CNF4, which can interact with zein, starch, and CNFs during the mixing process and therefore change the phase morphology of the composites.

### Energy Dispersive Spectroscopy (EDS)

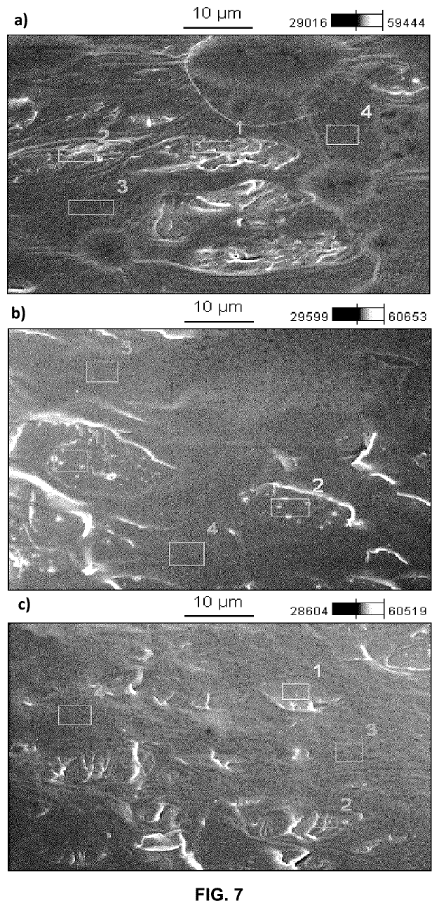

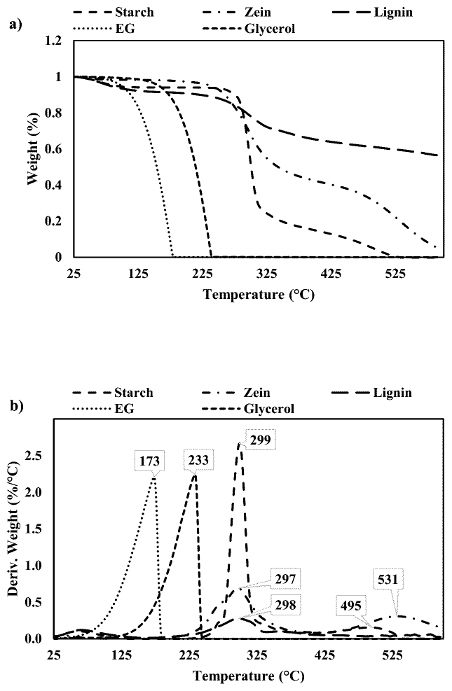

To understand the distribution of lignin in the composites, EDS was performed at four spots on the cross section of the composites (spots 1 & 2 on the zein domain and spots 3 & 4 on the starch domain) to analyze their elemental contents, as shown in FIG. 7. The elemental composition of lignin powder was also analyzed using EDS as a reference. The sodium (Na) and sulfur (S) contents for the lignin and the three composites GC, GS-2, and GP-2 are summarized in Table 6 for comparison. The contents of Na and S in the lignin powder were 5.28% and 3.35%, respectively. These two elements originated from the Kraft lignin production process where NaOH and Na₂S were used to dissolve the material. GC as the control sample contained no lignin and the contents of Na and S were very low. The relatively high content of S (0.48%) in the zein domain can be attributed to the —SH and —SS— groups of the protein. After the incorporation of either lignin solution (GS-2) or lignin powder (GP-2), the contents of Na and S were increased in both zein and starch domains of the composites (Table 6), indicating that lignin were dispersed in both domains. The increases in the content of Na appeared to be much greater than the increases of S for both domains and composites. For instance, in the starch domain, the content of Na increased from 0.15% (GC) to 0.67% (GS-2) and 0.96% (GP-2), whereas the content of S increased from 0.04% to 0.06% and 0.08% under the same condition. The greater increases in Na might be due to its higher mobility in the composites: dissolved in glycerol/water as ions, the element could be uniformed dispersed throughout the composites during the mixing. Therefore, strong Na signals could be detected by EDS at any spot on the cross-sectional surface. By contrast, S is covalently connected to lignin molecules and its distribution depends on the distribution of lignin. As shown in FIG. 4, lignin particles were scattered on the surface, suggesting ununiform distribution of S. In addition, the original content of S in the lignin powder was lower than that of Na (3.35% vs 5.28%). These two factors together result in relatively low detection rate of S in the composites.

TABLE 6

| | Lignin | GC | | GS-2 | | GP-2 | |
|---|---|---|---|---|---|---|---|
| | powder | Zein | Starch | Zein | Starch | Zein | Starch |
| Na—K | 5.28 | 0.02 | 0.15 | 0.1 | 0.67 | 0.37 | 0.96 |
| (atom %) | | | | | | | |
| S—K | 3.35 | 0.48 | 0.04 | 0.52 | 0.06 | 0.5 | 0.08 |
| (atom %) | | | | | | | |

### Thermogravimetric Analysis (TGA)

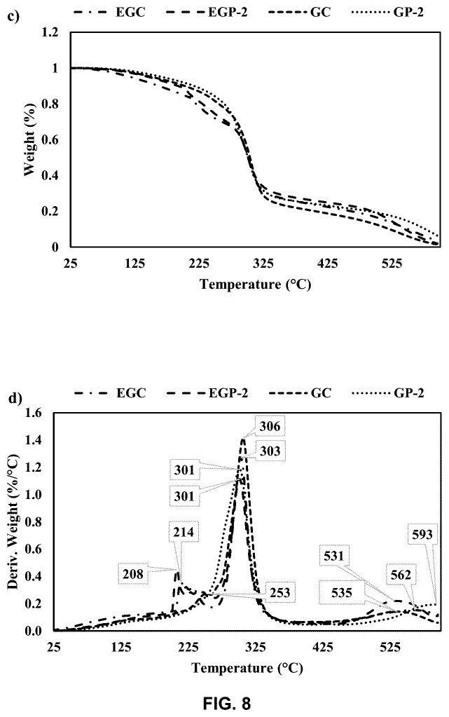

TGA was performed on the composites and their ingredients to determine the thermal stability of the composites. TGA curves of all the samples and their first derivative (DTG) curves are compared in FIG. 8. Based on FIG. 8A-B, the two plasticizers showed the lowest decomposition temperatures (173° C. and 233° C.) among all the ingredients. A simple one-step decomposition process was demonstrated by both materials. By contrast, all the three biobased ingredients, i.e., starch, zein, and lignin, exhibited more complicated decomposition behaviors due to their complex structures. Starch and zein showed mild weight losses below 100° C. due to the removal of moisture. A major rapid decomposition event occurred for all the three materials with a peak decomposition temperature at ˜300° C., followed by relatively slow further decomposition at higher temperatures.

In FIG. 8B, starch showed the highest weight loss rate among the three biobased ingredients at ˜300° C., which can be attributed to its relatively simple pyrolysis mechanism. Elimination of the hydroxyl groups, scission of the glycosidic and other covalent bonds, and possible transglucosidation occurs at this temperature range. The degradation peak at 495° C. corresponds to the oxidation of the material's carbonaceous residue.

The weight loss rate of zein at ˜300° C. was much lower than that of starch and the peak width was also widened to a range between ˜225° C. and ˜375° C. The process involved two overlapping thermal processes, which likely corresponded to volatilization of impurities and thermal degradation of zein, with their peak temperatures at 260 and 300° C., respectively. At temperatures higher than 420° C. the degradation residue of zein is oxidized. The peak at around 530° C. may be due to the degradation of impurity included in the product.

Among the three natural biopolymers, lignin showed the highest thermal stability, featuring the lowest weight loss rate at ˜300° C. and the highest residual weight of ˜56% at 600° C. The thermal degradation of lignin in air consisted of three main steps and resulted in a weight loss over a broad range of temperatures (25-600° C.). The weight loss below 125° C. was due to moisture evaporation and scission of the side chains which led to the release of CO, CO₂, and other volatile products. Between 200 and 400° C., the inter-unit bonds were fractured and thereby monomer phenol was released in the vapor phase. Above 400° C., the sample mass loss was related to the decomposition or condensation reactions of aromatic rings and the oxidation of the degradation products. The large amount of char residue at 600° C. (˜56%) can be attributed to the high aromatic content of lignin. Similar observations have been reported by other researchers.

The decomposition of the composites was largely controlled by that of the ingredients. From FIG. 8D, the peak degradation temperature of ethylene glycol in the composites (EGC and EGP-2) was increased to 208-214° C., significantly higher than that of the free plasticizer (173° C.). The peak temperature for starch and zein was also increased to ˜305° C. from less than 300° C. These increases can be partially attributed to the different forms of the materials: free liquid or loose powder as the neat ingredients versus compact solid pieces of the composites. The latter exhibit stronger resistance to mass and heat transfer than the former and therefore show lower weight loss rates. Another reason for ethylene glycol's much higher degradation temperature in the composites than its free form is that the plasticizer likely forms hydrogen bonds with starch and zein, leading to a higher energy requirement for its degradation. Moreover, instead of one sharp decomposition peak for the free-form ethylene glycol, the decomposition of the bond ethylene glycol occurred over a ˜50° C. range starting from the peak temperature, indicating again the slowed degradation and improved thermal stability.

FIG. 8D also shows that the decomposition peak temperature of glycerol was increased to 253° C. in the composites (GC and GP-2). Its weight loss rate was much lower than that of ethylene glycol in the composites, which is likely due to glycerol's higher polarity and stronger bonding to starch and lignin. The main decomposition peaks of the composites range from 301° C. to 306° C., as shown in FIG. 8D. These peaks correspond to the degradation peaks of starch, zein, and lignin within the temperature range 297° C.-299° C. in FIG. 8B, suggesting slight improvements in thermal resistance of the ingredients.

Focusing on the weight loss of the composites (FIG. 8C), the composites containing glycerol as their plasticizer (i.e. GC & GP-2) showed a lower weight loss below 275° C. compared to the composites containing ethylene glycol (e.g. EGC & EGP-2). This is due to the higher thermal stability of glycerol than ethylene glycol as discussed previously. The composites containing lignin (i.e. EGP-2 & GP-2) also showed a slightly lower weight loss than the composites without lignin (i.e. EGC & GC) over most of the test temperature range. The difference can be attributed to the high thermal stability of lignin.

### Conclusion

Glycerol-plasticized and ethylene plasticized composites were prepared using internal mixer. The incorporation of lignin particles can significantly improve the mechanical properties of starch-zein blend regardless of the plasticizer types as demonstrated by tensile test and scanning electron microcopy (SEM) micrographs, especially the incorporation of the powder lignin which appears to lead to higher overall mechanical properties and smaller domain size of zein phase in the blends than incorporation of lignin nanoparticle solutions. With the increasing lignin content, the mechanical properties of blends increased, which indicated better interfacial bonding between starch and zein, especially for GP-2. Compared to control sample (GC sample), the modulus and tensile strength of the GP-2 sample were increased by ˜300% and ˜130%, respectively. The introduced of cellulose nanofibrils (CNFs) were further enhanced the modulus and strength of the blends. Compared to control sample (GC sample), the modulus and strength of GC-CNF6 sample were increased by ˜400% and ˜140%, respectively. The GP-2-CNF6 exhibited the largest increases in modulus (˜510%) and strength (˜240%), suggesting strong synergy between lignin and CNFs in reinforcing the corn-based thermoplastic. However, the thermogravimetric analysis showed that the thermal stability of the blends was only slightly improved with the incorporation of lignin.

### Example 2

### Use of Citric Acid as a Processing Aid for Thermoplastic Starch-Zein Composites

In this Example, citric acid was used to replace water as the processing aid and compatibilizer/crosslinker in the composite formulations studied in Example 1. The incorporation of citric acid was hypothesized to improve the processability of native starch, improve the thermostability of the composites and improve the compatibility between starch and zein, and therefore increase the mechanical properties of the new thermoplastic.

### Materials

Argo® pure corn starch (10% moisture) was purchased from a local grocery store. Zein (F4400C-FG) and glycerol (99+%) were purchased from Flo Chemical and Alfa Aesar, respectively. Kraft lignin and citric acid monohydrate were purchased from Sigma-Aldrich. The lignin contained 4% sulfur and had an average Mw of ˜10,000. CNF slurry (CNFs dispersed in water) with a CNF concentration of ˜2.5 wt % was purchased from the Process Development Plant of the University of Maine. All the chemicals and materials were used as received without further purification or modification.

### Methods

### Preparation of Thermoplastic Composites

Citric acid (CA) and glycerol were used as the crosslinker and plasticizer in the product, respectively. To prepare the CNFs/glycerol/CA mixtures, CA was dissolved in glycerol (CA:glycerol=0.5:35 by weight) by stirring with a high-speed homogenizer (IKA® T25 digital ULTRA-TURRAX®) at 3600 rpm for 10 min. The received CNF slurry was concentrated using a centrifuge (Eppendorf® Centrifuge 5804) to increase the concentration to ˜12 wt %. Next, predetermined amounts of the concentrated CNF slurry were added into the CA/glycerol solution to obtain CNF/glycerol/CA mixtures with the ratios of the three components at x/35/0.5 (w/w/w, x=2, 4, 6). The mixtures were sonicated (Sonicators® 3000) in an ice bath to break apart CNF agglomerates and achieve stable, homogeneous CNF suspensions in CA/glycerol. Finally, the sonicated suspensions were placed in a Lab-Line vacuum oven (Thermo Fisher Scientific) at 90° C. and 80 inHg to remove the water (brought into the mixtures by the CNF slurry). The paste-like water-free mixtures were sealed and stored under ambient conditions for future use. The formulations and sample codes of the obtained CNF mixtures are listed in Table 7.

TABLE 7

| | Ingredients (All in parts) | | |
|---|---|---|---|
| Sample Code | Glycerol | Citric Acid | Cellulose Nanofiber |
| CNF2 | 35 | 0.5 | 2 |
| CNF4 | 35 | 0.5 | 4 |
| CNF6 | 35 | 0.5 | 6 |

Starch, zein, and lignin were all in dry powder format. They were weighted and manually mixed in a beaker following the formulations listed in Table 8. The powder mixtures were then blended with the prepared CNFs/glycerol/CA mixtures in a kitchen blender and then sealed in a plastic bag and stored overnight to achieve equilibrium. In the sample codes of Table 8, SZ denotes the starch/zein mixture, which were the matrix materials of the composites. LP denotes the lignin powder. The numbers after the LP and CNF indicate the number of grams for the lignin and CNFs (dry weight). For instance, SZ-LP6-CNF6 means that the composite contains 6 grams of lignin powder and 6 grams of CNFs. Letter C in the sample codes of SZC indicates that the denoted sample is control a sample containing no lignin and CNFs.

TABLE 8

| | Ingredients (All in parts) | | | | | |
|---|---|---|---|---|---|---|
| Sample Code | Starch | Zein | Glycerol | CA | Lignin | CNF |
| SZC | 88.89 | 20 | 35 | 0.5 | 0 | 0 |
| SZ-CNF4 | 88.89 | 20 | 35 | 0.5 | 4 | 0 |
| SZ-CNF6 | 88.89 | 20 | 35 | 0.5 | 6 | 0 |
| SZ-CNF10 | 88.89 | 20 | 35 | 0.5 | 10 | 0 |
| SZ-LP4 | 88.89 | 20 | 35 | 0.5 | 0 | 4 |
| SZ-LP6 | 88.89 | 20 | 35 | 0.5 | 0 | 6 |
| SZ-LP10 | 88.89 | 20 | 35 | 0.5 | 0 | 10 |
| SZ-LP4-CNF4 | 88.89 | 20 | 35 | 0.5 | 4 | 4 |
| SZ-LP6-CNF6 | 88.89 | 20 | 35 | 0.5 | 6 | 6 |

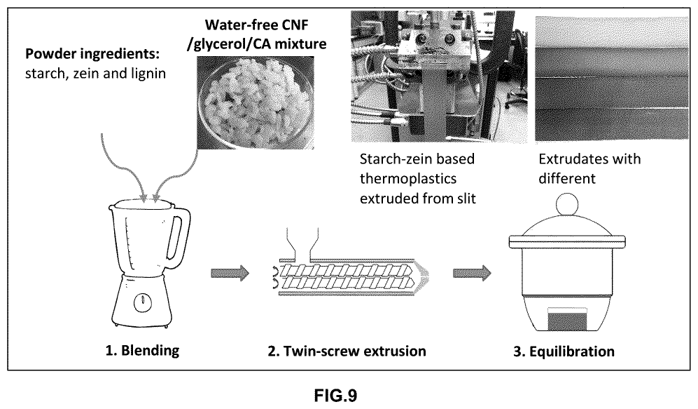

The equilibrated composite formulations were compounded into thermoplastics using a co-rotating HAAKE twin-screw extruder (Rheomex™ PTW16 OS, screw diameter d=16 mm, screw L/D ratio=40:1, Germany) operating at 100 rpm. The extruder temperatures were set to 90° C., 120° C., 140° C., 140° C., 140° C., 140° C., 140° C., 140° C., and 140° C. from the feed zone to the die. The thermoplastics were extruded through a slit die with a 25 mm×0.5 mm rectangular opening (Thermo Electron) to produce ribbon-like extrudates, which were sealed in plastic bags immediately after extrusion and were transferred into a desiccator (˜45% relative humidity at 20° C.) and stored for 24 h before testing. The flow chart of the sample preparation process is shown in FIG. 9.

### Mechanical Properties of the Starch-Zein-Based Thermoplastics

Dumbbell shaped tensile test bars were cut from the extruded ribbons. Tensile tests were performed under ambient conditions (˜23° C.) on an MTS Insight test system equipped with a 5 kN electronic load cell at a crosshead speed of 50 mm/min.

### Scanning Electron Microscopy (SEM)

Scanning electron microscopy (SEM) was used to study the morphology of the microstructure of the composites. Samples were frozen and fractured in liquid nitrogen to produce a clean cross section. They were attached to aluminum mounts with colloidal silver paste (Structure Probe Inc., West Chester PA, USA) for view of the fractured surface and then coated with a conductive layer of gold using a Cressington 108 auto sputter coater (Ted Pella Inc., Redding CA, USA). Images were obtained at an accelerating voltage of 15 kV using a JEOL JSM-6490LV scanning electron microscope (JEOL USA, Peabody MA, USA).

### X-Ray Diffraction

X-ray diffraction (XRD, Bruker D8 Discover X-ray diffractometer) measurements were operating at 40 kV and 40 mA with Cu Kα source (λ=0.154 nm). The scanning rate is 2°/min. The 2θ range was 3-58°.

### Fourier Transform Infrared Spectrometry (FTIR)

Fourier-transform infrared spectroscopy (FTIR, Thermo Scientific Nicolet 8700 FTIR spectrometer) was used to characterize the chemical bonds of native ingredients (starch, zein, lignin, CNF) and their film composite samples. FTIR spectra (4000-650 cm⁻¹) were collected using an ATR accessory for both powder and film composite samples.

### Thermogravimetric Analysis (TGA)

Thermogravimetric analysis (TGA, TA Instruments Q500) was performed to determine the thermal stability of the composites and the constituents. All sample were tested between room temperature and 600° C. with a heating rate of 10° C./min under a continuous air flow (60 ml/min).

### Results and Discussion

### Mechanical Properties

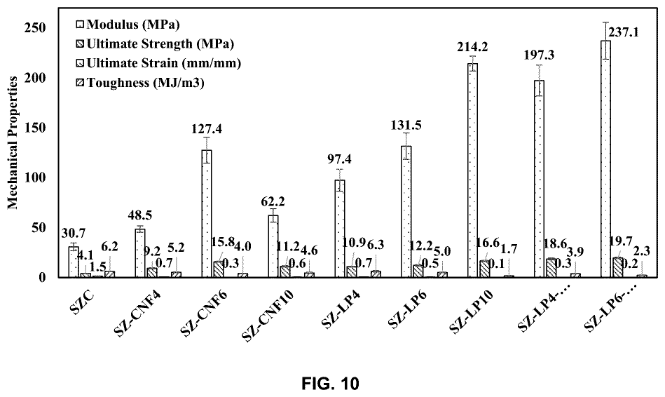

Tensile test results for all the formulations listed in Table 8 are compared in FIG. 10. The composites reinforced by lignin and the composites reinforced by CNF showed a similar property trend (except for SZ-CNF10): a higher reinforcement content (lignin or CNF) led to higher strength and modulus of the samples. The composites containing both lignin and CNF exhibited the highest strength and modulus. While the strength and modulus were improved, the ultimate strain and toughness of the samples were decreased as the samples became increasingly rigid. The incorporation of six grams of lignin and six grams of CNFs led to the best overall mechanical properties among all the formulations. Table 9 summarizes the percentage changes of the properties for all the composites compared to those of the control sample SZC. The decreases in strength and modulus for the SZ-CNF10 sample may be attributed to poor dispersion of CNFs and other defects in the composites. It was noticed that the extrusion became very difficult (high torque, overheating, etc.) at the high CNF content due to the high viscosity of the material, which could cause a series sample defects including inhomogeneous blending, material thermal degradation, etc.

For the composites containing both lignin and CNFs, they all exhibited much higher moduli and strengths compared to the composites containing only lignin or CNFs, see FIG. 10 and Table 9. The modulus of SZ-LP4-CNF4 was 2.0 and 4.1 times that of SZ-LP4 and SZ-CNF4, respectively, whereas the strength of SZ-LP4-CNF4 was 1.7 and 2.0 times that of the two single-reinforcement composites. For SZ-LP6-CNF6, its modulus was 1.8 and 1.9 times that of SZ-LP6 and SZ-CNF6, respectively; its strength was 1.6 and 1.2 times that of the two composites. The increases in mechanical properties of the dual-reinforcement composites were even more significant when compared with the control sample (SZC). For example, the moduli of SZ-LP4-CNF4 and SZ-LP6-CNF6 were increased by 542.2% and 671.8%, respectively, while their strengths were increased by 360.0% and 386.4%. It should be pointed out that the composites containing both lignin and CNFs exhibited reduced ultimate strain and toughness compared to the control sample and the samples containing only lignin or CNF. The increases in the modulus and strength and the reduction in the strain can be both attributed to the synergetic reinforcement effect of the lignin and CNFs on the corn-based thermoplastic. Lignin nanoparticles in the starch-zein blend have been shown to refine the phase structure of the blend and increase the compatibility of the two phases, leading to improved mechanical properties. CNFs as a nanofibrous material is known to significantly reinforce polymers at low fiber concentrations. The interactions between the nanomaterials and the polymer chains reduced the mobility of the chains and resulted in decreased strain and toughness.

### SEM

TABLE 9

| | | Ultimate | Ultimate | |
|---|---|---|---|---|
| | Modulus | Strength | Strain | Toughness |
| SZC | 0.0% | 0.0% | −0.3% | −0.1% |
| SZ-CNF4 | 57.7% | 127.7% | −49.1% | −16.2% |
| SZ-CNF6 | 314.8% | 290.8% | −76.2% | −35.0% |
| SZ-CNF10 | 102.3% | 176.2% | −59.7% | −24.8% |
| SZ-LP4 | 217.0% | 169.3% | −54.3% | 2.0% |
| SZ-LP6 | 328.1% | 201.0% | −67.2% | −18.2% |
| SZ-LP10 | 597.1% | 310.8% | −90.0% | −73.1% |
| SZ-LP4-CNF4 | 542.1% | 360.0% | −80.4% | −36.3% |
| SZ-LP6-CNF6 | 671.7% | 386.4% | −88.8% | −63.5% |

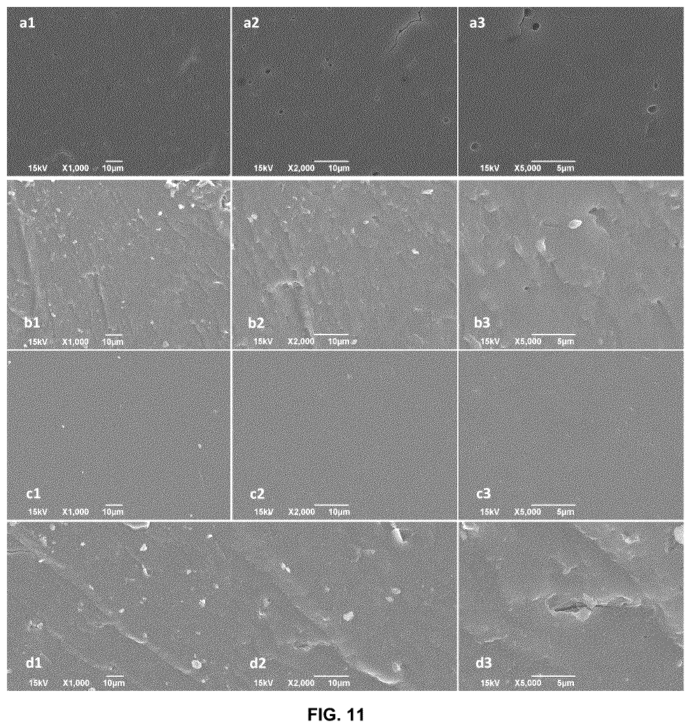

The fracture surface of the control sample SZC was flat and smooth as shown in FIG. 11A. Compared with the SEM images of the samples (containing no citric acid) in Chapter 3, no “sea-island” phase structure was observed on the fracture surface of SZC (FIG. 11A), indicating that the compatibilizing effect of CA on starch and zein. Under high shear and high temperature conditions, glycerol and citric acid will be able to disrupt intermolecular and intramolecular hydrogen bonds and plasticize native starch. Besides, citric acid can obviously decrease the shear viscosity and improve the processability of TPS by promoting the fragmentation and dissolution of cornstarch granules.

The surface of the composites containing lignin (FIG. 11C) was similar to that of the control sample, demonstrating lignin's good compatibility with the system. The fracture face of the sample containing CNFs (FIG. 11B) is however rougher compared with the first two samples. The rough surface can be an indication of CNF agglomeration in the composite. During its sample preparation, concentrated CNF slurry was mixed with glycerol/CA solution using a sonicator and then dried in the oven to achieve a water-free condition. The resulting mixture was a highly viscous, paste-like material, which caused high torque and overheating in the subsequent twin-screw extrusion. The difficulties experienced in processing the sample contributed to the ununiform phase structure and further to the relatively low mechanical properties of the SZ-CNF10 sample as found from the tensile test in the previous section.

### XRD

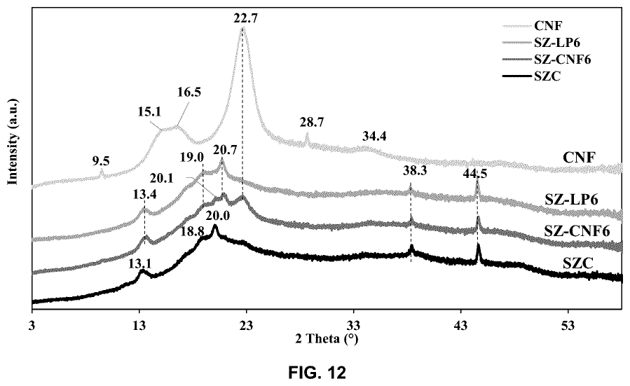

XRD was used to investigate the crystalline structure of the samples. FIG. 12 exhibits the XRD patterns of the CNF, SZC, SZ-LP6 and SZ-CNF6. CNFs showed diffraction peaks at 2θ 34.4°, 22.7°, 15.1° and 16.4°, which are the characteristic diffraction patterns of cellulose I crystals. The diffraction peaks at ˜9.5° and 29° may be due to impurities in the sample. Thermoplastic starch is almost amorphous right after extrusion because starch crystals are disrupted/melted under the shear and heat. However, starch can recrystallize if aged above its glass transition temperature. The short outer chains of amylopectin crystallize into the B-type structure, with a characteristic peak at 16.8°. The crystallization of amylose involving glycerol can form V-type crystalline structure, which can be further categorized into two subtypes, Va (anhydrous) and Vh (hydrated). Va shows XRD peak at 13.2° and 20.6°, while Vh has peaks at 12.6° and 19.4°. In this study the control sample SZC showed peaks at 13.1°, 18.8°, and 20.0°, indicating recrystallization of starch in the sample. These three peaks were shifted to higher angles in the SZ-LP6 and SZ-CNF6 composites, suggesting a reduction in the crystal cell size and the refining of the starch crystal structure in the presence of lignin or CNFs. The two peaks at 38.3° and 44.5° on the diffraction patterns of all the composite are due to CA. Zein became completely amorphous after the extrusion and displayed no diffraction peaks in the figure.

### FTIR

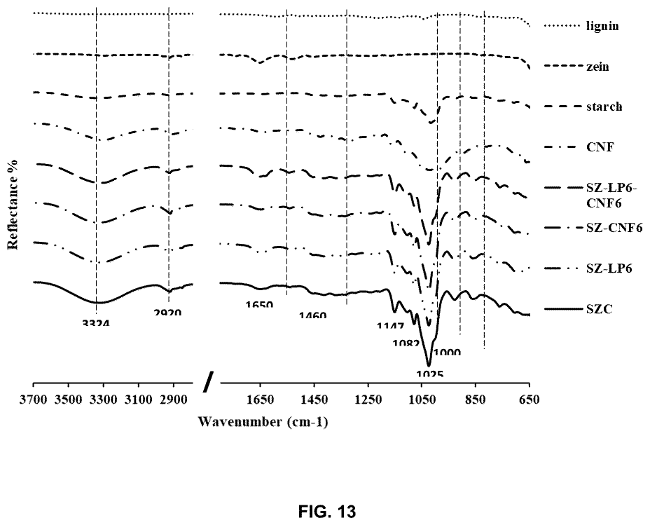

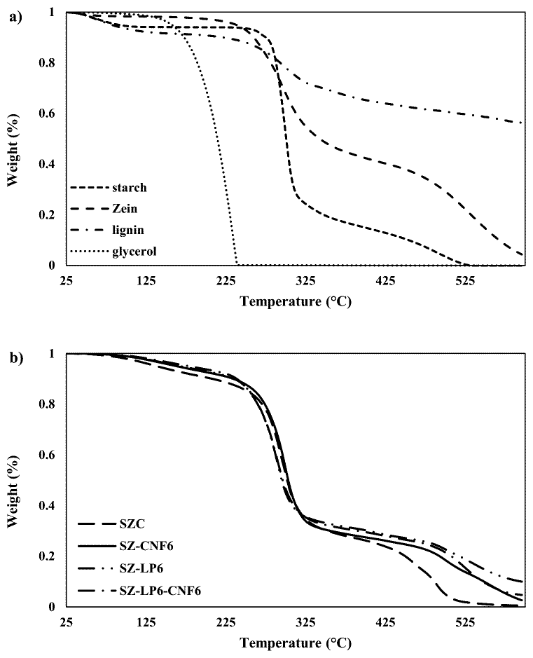

The amorphous state of starch could be identified by the band at 1025 cm⁻¹, while the band at 1047 cm⁻¹ was assigned to crystalline state of starch. The signal around 1000 cm⁻¹may corresponded to water sensitive of sample which related to intramolecular hydrogen bonding of hydroxyl groups. All extruded sample revealed two peaks at 1000 and 1025 cm⁻¹ in the FTIR spectra, as shown in FIG. 13. This may be related to the —OH and —COOH groups of citric acid form hydrogen bonding with both C—O—H and C—O—C groups in starch, C—O—H group in glycerol, as well as the —NH group from zein. The results reveal that both amorphous phase and crystalline phase of starch were occurred in the extruded sample.

The band referring to C═O stretching of the amide group occurred at 1650 cm⁻¹ in native zein, as well as starch-zein based composites. The band at 1645 cm⁻¹ was ascribed to the bending vibration of H—O—H from water. The stretching vibrations band at 3324 cm⁻¹ could be attributed to the oxidation in the ambient environment and adsorbed water. The band at 2920 cm⁻¹ may attribute to —CH₂ stretching vibration from starch. Band at 1147 cm⁻¹ and 1082 cm⁻¹ may both corresponded to C—O—H stretching vibration. The absorption band at 1460 cm⁻¹ was attributed to the N—H bending and C—N stretching combination. FTIR spectra showed no noticeable peak shifting.

### TGA

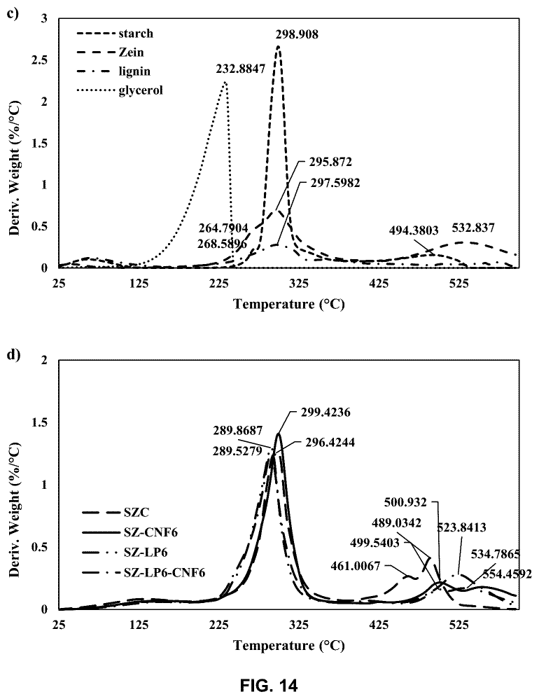

TGA study was conducted over a temperature range of 25-600° C. to identify the thermostability of the native ingredients and the extruded composites. FIG. 14 presents the results of TGA and differential thermogravimetry (DTG) curves. The weight loss below 100° C. was mainly ascribed to water loss. Overall, after heating the films to 600° C., the lignin-containing starch-zein blends showed a lower weight loss than the composites without lignin, which can be attributed to lignin's high thermal stability. Table 10 shows the native ingredients and composites' peak degradation temperature. The residual weight of lignin was ˜56% at 595.6° C. Compared to SZC, the remaining weight of SZ-LP6 was 10% higher, suggesting that the incorporation of lignin could improve the thermal stability of the starch-zein blends.

TABLE 10

| | Peak Degradation | | | | 80% Weight | |
|---|---|---|---|---|---|---|
| | Temperature (° C.) | | | | Loss | Remaining |
| | 1^{st} | 2^{nd} | 3^{rd} | 4^{th} | Temperature | Weight at |
| | stage | stage | stage | stage | (° C.) | 595.6° C. |
| Starch | 58.6 | 298.9 | 494.4 | — | 347.1 | 0% |
| Zein | 264.8 | 295.9 | 532.8 | — | 532.0 | 4.4% |
| Lignin | 62.3 | 297.6 | — | — | N/A* | 56.4% |
| Glycerol | 232.9 | — | — | — | 230.1 | 0% |
| SZC | 130.9 | 296.4 | 461.0 | 489.0 | 449.5 | 0.6% |
| SZ-CNF6 | 140.9 | 299.4 | 500.9 | 554.5 | 492.6 | 2.6% |
| SZ-LP6 | 144.6 | 289.9 | 499.5 | 534.8 | 517.5 | 10% |
| SZ-LP6-CNF6 | 147.2 | 289.5 | 523.8 | — | 507.2 | 4.7% |

*Not applicable.

Thermal degradation of starch involves the dehydration and main chain secession. The starch DTG curve has three peaks, 58.6° C., 298.9° C. and 494.4° C., respectively. The first weight loss occurred between room 25° C. to 100° C., which was due to the loss of the absorbed and bound water. The second degradation peak at around 300° C. is due to starch thermal decomposition. The third weight loss observed at 495° C. may be ascribed to the oxidation of the carbonaceous residues, during which CO₂ and CO are produced from oxygen-containing materials from 350° C. to 500° C.

The DTG curve of zein had two major peaks with the first maximum at 297° C. and the second one at 531° C. The first one appeared to include overlapping thermal processes which were likely caused by the volatilization of impurities and the pyrolysis of zein. The second peak may be due to the degradation of impurity included in the product.

As shown in Table 10, 80% weight loss of the composites occurred was between native corn starch (347° C.) and zein (532° C.). temperature This indicated that the presence of citric acid increased the compatibility between starch and zein. Composites incorporated with only 6 parts of lignin and 6 parts of CNFs show two degradation peaks between the last degradation peak of starch and zein or even above, which confirmed the improvement of their thermal stability compared to pure starch and zein. In addition, by comparing FIG. 14D with FIG. 14B, it could be easily noted that the third degradation peaks of SZ-LP6-CNF6 only exhibits one degradation peak between 494.4° C. and 532.8° C., in other word, this composite showed the best compatibility between ingredients. The exception of SZC may be due to the possibly acidolysis of starch occurred in the system as a side reaction. So, although the addition of citric acid can improve the thermal stability of the composite, the possibly side reaction could decrease the thermal stability of thermoplastic starch. In conclusion, the incorporation of both lignin and CNFs enhanced the compatibility between starch and zein the most. This may be contributed to the highest shear rate caused by the addition of both reinforcement agents.

### Conclusion

Corn-based thermoplastics with high mechanical properties were developed from this research. Lignin and CNFs, two biobased materials derived from plants, were the critical ingredients that provided significant reinforcement to the corn plastics. The purified starch/zein mixture could be used as the main feedstock to produce the plastics. However, the cornmeal had a great cost advantage over the starch/zein mixture while offering similar product properties. With the increasing lignin and cellulose nanofibrils content, the mechanical properties of blends increased, except SZ-CNF10 sample. The extrusive may due to the dispersion status of CNF. With relatively low plasticizer content, more cellulose granular structures were found from the SEM image which decreased blends modulus and strength on the contrary compared to SZ-CNF6 sample. SZ-LP6-CNF6 exhibited the largest increases in modulus and strength, 671.7% and 386.4% respectively, compared to the control sample (SZC). The “sea-island” structure was no longer be found in the citric acid included blends, which may be ascribed to the better compatibility between starch and zein. Besides, the addition of citric acid improved thermal stability of composites compared to pure starch and zein, except for SZC. The exception was possibly ascribed to the acidolysis of starch occurred in the system as a side reaction.

### Example 3

### Thermoplastic Composites Based on Cornmeal

Zein was use as a hydrophobic ingredient in the previous Examples to increase the mechanical properties and water barrier properties of TPS. However, zein is an expensive material ($20-70 per kg) compared to other biopolymers due to the costly material separation and purification processes in zein production. Thus, to find an economic substitute for zein becomes very important for large scale industrial applications of the corn plastic. In this Example, it was hypothesized that the replacement of starch and zein with cornmeal is feasible because of the main ingredients of cornmeal being starch and zein. The goal of this study is to evaluate the potential of using cornmeal as a substitute to the starch-zein matrix to decrease the cost of the product for large scale industrial. Lignin and CNFs were also evaluated as the compatibilizer and reinforcement for the cornmeal-based thermoplastics.

### Materials

Cornmeal (B07NZPQ2RM, Homestead Gristmill Stone Ground Yellow Cornmeal) was purchased from Amazon. The lignin contained 4% sulfur and had an average Mw of ˜10,000. Glycerol (99+%, 11443297) was purchased from Alfa Aesar. CNF slurry with a CNF concentration of ˜2.5 wt % was purchased from the Process Development Plant of University of Maine. The slurry was concentrated by centrifugation to 10 wt % before use. All the chemicals and materials were used as received without further purification or modification.

### Methods

### Preparation of Thermoplastic Composites

Citric acid (CA) and glycerol were used as the crosslinker and plasticizer in the product, respectively. To prepare the CNFs/glycerol/CA mixtures, CA was dissolved in glycerol (CA:glycerol=0.5:35 by weight) by stirring with a high-speed homogenizer (IKA® T25 digital ULTRA-TURRAX®) at 3600 rpm for 10 min. The received CNF slurry was concentrated using a centrifuge (Eppendorf® Centrifuge 5804) to increase the concentration to ˜12 wt %. Next, predetermined amounts of the concentrated CNF slurry were added into the CA/glycerol solution to obtain CNF/glycerol/CA mixtures with the ratios of the three components at x/35/0.5 (w/w/w, x=2, 4, 6). The mixtures were sonicated (Sonicators® 3000) in an ice bath to break apart CNF agglomerates and achieve stable, homogeneous CNF suspensions in CA/glycerol. Finally, the sonicated suspensions were placed in a Lab-Line vacuum oven (Thermo Fisher Scientific) at 90° C. and 80 inHg to remove the water (brought into the mixtures by the CNF slurry). The water-free mixtures appeared like pastes and they were sealed and stored under ambient conditions for future use. The formulations and sample codes of the obtained CNF mixtures are listed in Table 11.

TABLE 11

| | Ingredients (All in parts) | | |
|---|---|---|---|
| Sample Code | Glycerol | Citric Acid | Cellulose Nanofiber |
| CNF2 | 35 | 0.5 | 2 |
| CNF4 | 35 | 0.5 | 4 |
| CNF6 | 35 | 0.5 | 6 |

Cornmeal and lignin in dry powder form were weighted and manually mixed in a beaker following the formulations listed in Table 12. The powder mixtures were then blended with the prepared CNFs/glycerol/CA mixtures in a kitchen blender and then sealed in a plastic bag and stored overnight to achieve equilibrium. In the sample codes of Table 12, SZ and CM denote the starch/zein mixture and cornmeal, respectively, which were the two matrix materials of the composites. LP denotes the lignin powder. The numbers after the LP and CNF indicate the number of grams for the lignin and CNFs (dry weight). For instance, CM-LP6-CNF6 means that the composite contains 6 grams of lignin powder and 6 grams of CNFs. Letter C in the sample codes of CMC indicates that the denoted samples are control samples containing no lignin and CNFs.

TABLE 12

| | Ingredients (All in parts) | | | | |
|---|---|---|---|---|---|
| Sample Code | Cornmeal | Glycerol | CA | Lignin | CNFs |
| CMC | 108.89 | 35 | 0.5 | 0 | 0 |
| CM-LP2-CNF2 | 108.89 | 35 | 0.5 | 2 | 2 |
| CM-LP4-CNF4 | 108.89 | 35 | 0.5 | 4 | 4 |
| CM-LP6-CNF6 | 108.89 | 35 | 0.5 | 6 | 6 |

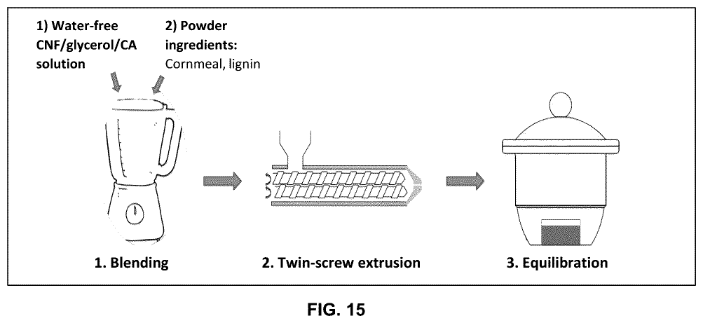

The equilibrated composite formulations were compounded into thermoplastics using a corotating HAAKE twin-screw extruder (Rheomex™ PTW16 OS, screw diameter d=16 mm, screw L/D ratio=40:1) operating at 100 rpm. The extruder temperatures were set to 90° C., 120° C., 140° C., 140° C., 140° C., 140° C., 140° C., 140° C., and 140° C. from the feed zone to the die. The thermoplastics were extruded through a slit die with a 25 mm×0.5 mm rectangular opening (Thermo Electron) to produce ribbon-like extrudates, which were sealed in plastic bags immediately after extrusion and were transferred into a desiccator (˜45% relative humidity at 20° C.) and stored for 24 h before testing. The flow chart of the sample preparation process is shown in FIG. 15.

### Mechanical Properties of the Corn-Based Thermoplastics

Dumbbell shaped tensile test bars were cut from the extruded ribbons. Tensile tests were performed under ambient conditions (˜23° C.) on an MTS Insight test system equipped with a 5 kN electronic load cell at a crosshead speed of 50 mm/min.

### Scanning Electron Microscopy (SEM)

Scanning electron microscopy (SEM) was used to study the morphology of the microstructure of the composites. Samples were frozen and fractured in liquid nitrogen to produce a clean cross section. They were attached to aluminum mounts with colloidal silver paste (Structure Probe Inc., West Chester PA, USA) for view of the fractured surface and then coated with a conductive layer of gold using a Cressington 108auto sputter coater (Ted Pella Inc., Redding CA, USA). Images were obtained at an accelerating voltage of 15 kV using a JEOL JSM-6490LV scanning electron microscope (JEOL USA, Peabody MA, USA).

### Fourier Transform Infrared Spectrometry (FTIR)

Fourier-transform infrared spectroscopy (FTIR, Thermo Scientific Nicolet 8700 FTIR spectrometer) was used to characterize the chemical bonds of native ingredients (starch, zein, lignin, CNF) and their film composite samples. Both powder and film composite samples were characterized using ATR accessory (4000-650 cm⁻¹) to collect their FTIR spectra.

### Results and Discussion

### Mechanical Properties

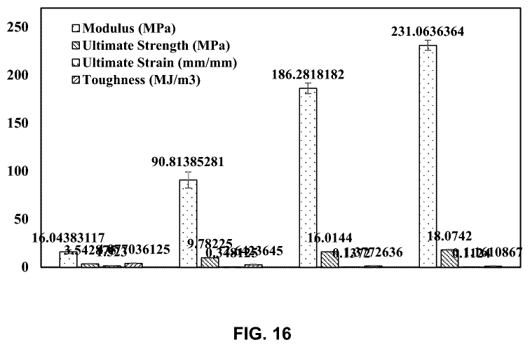

Tensile test results for all the formulations listed in Table 12 are compared in FIG. 16. The composites incorporated with both lignin and CNF exhibited the highest strength and modulus. While the strength and modulus being improved, the ultimate strain and toughness of the samples were decreased as the samples became increasingly rigid. The incorporation of six grams of lignin and six grams of CNFs led to the best overall mechanical properties.

The control sample based on cornmeal (CMC) showed a lower modulus and strength than those of the control sample based on the starch/zein mixture. This may be attributed to the fact that the cornmeal contained 4.14% fat, which can function as a plasticizer to soften the material (Table 13). By comparing CM-LP2-CNF2, CM-LP4-CNF4, and CM-LP6-CNF6 with the control sample (Table 14), the moduli of the composites were increased by 466%, 1061.1%, and 1340.2%, respectively, while the strengths were increased by 176.1%, 352%, and 410.2%, respectively. Indeed, the cornmeal-based composites exhibited a property trend similar to that of the starch/zein based composites. The percentage increases in the properties were even larger for the former than for the latter. The moduli and strengths of CM-LP4-CNF4 and CM-LP6-CNF6 were comparable to those of SZ-LP4-CNF4 and SZ-LP6-CNF6 (Chapter 4), whereas the ultimate strain/toughness of the former (cornmeal-based composites) was lower. This may be due to the presence of pericarp (skin of corn kernel) in the composites, which can cause premature sample fracture due to its relatively large size. The above results confirm that low-cost cornmeal can be reliably used to replace the expensive starch/zein mixture to produce corn plastics with similar properties.

TABLE 13

| | Ash | CP | N | Fat | Starch | NDF | ADF | ADL | Ca | Phos |
|---|---|---|---|---|---|---|---|---|---|---|
| Sample | (%) | (%) | (%) | (%) | (%) | (%) | (%) | (%) | (%) | (%) |
| Stoneground | 1.38 | 7.58 | 1.21 | 4.14 | 75.34 | 11.90 | 2.60 | 0.56 | 0.01 | 0.34 |
| Cornmeal | | | | | | | | | | |

CP: Crude protein;
ADF: Acid detergent fiber;
ADL: Acid detergent lignin;
NDF: Acid detergent fiber;
Phos: Phosphorus

TABLE 14

| | | Ultimate | Ultimate | |
|---|---|---|---|---|
| | Modulus | Strength | Strain | Toughness |
| CMC | 0.0% | 0.0% | −0.3% | −0.1% |
| CM-LP2-CNF2 | 466.0% | 127.7% | −49.1% | −16.2% |
| CM-LP4-CNF4 | 1061.1% | 290.8% | −76.2% | −35.0% |
| CM-LP6-CNF6 | 1340.2% | 176.2% | −59.7% | −24.8% |

### SEM

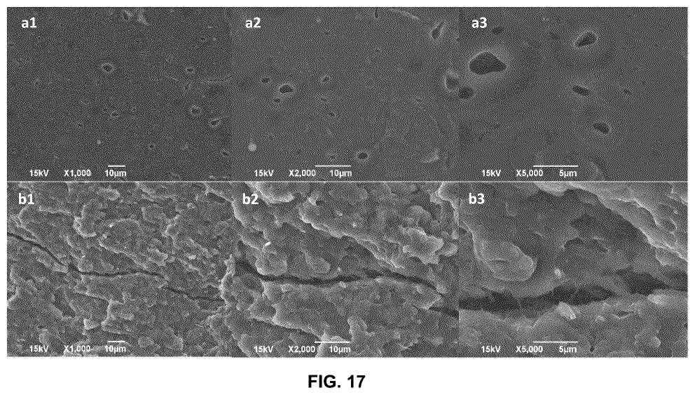

FIG. 17 exhibits the SEM micrographs of cornmeal control sample (CMC) and the cornmeal sample incorporated with 6 parts of lignin powder and 6 parts of cellulose nanofibrils (CM-LP6-CNF6). Compared to the fracture surface of CMC (FIG. 17A), the facture surface of CM-LP6-CNF6 was significantly rougher. There are visible pores or cracks showed on the surface of the fractured cross-section. The pores may be due to the possibility degradation of cornmeal at high temperature processing. The other reason would be the incorporation of citric acid may react with the moisture (˜10%) in the cornmeal and generate bubble in the sample as a result. The cracks showed on FIG. 17B may be ascribed to the relatively rigid property of the sample after the addition of lignin and cellulose nanofibrils. There are some bonds found in the crack, which may be due to the incorporation of nanofibrils.

### FTIR

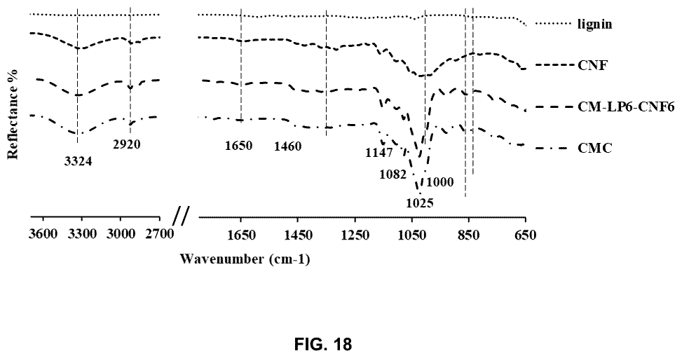

FIG. 18 shows the Fourier transform infrared spectroscopy (FTIR) spectra of lignin, CNF, CMC and CM-LP6-CNF6. The stretching vibrations band at 3324 cm⁻¹ could be attributed to the oxidation in the ambient environment and adsorbed water. The band at 2920 cm⁻¹ is attributed to —CH₂ stretching vibration from starch ingredient in cornmeal. The bands at 1147 cm⁻¹ and 1082 cm⁻¹ can be ascribed to C—O—H stretching vibration. The band at 1650 cm⁻¹ is due to C═O stretching of the amide group. The absorption band at 1460 cm⁻¹ was attributed to N—H bending and C—N stretching from the protein ingredient in cornmeal. However, there's not much different found between CMC and CM-LP6-CNF6 from the FTIR spectra.

### Conclusion

The composites incorporated with both lignin and CNF exhibited the highest strength and modulus for the cornmeal-based thermoplastic. While the strength and modulus being improved, the ultimate strain and toughness of the samples were decreased as the samples became increasingly rigid. The incorporation of six grams of lignin and six grams of CNFs led to the best overall mechanical properties. Compared to the cornmeal-based control sample (CMC), the modulus of CM-LP6-CNF6 was increased by 1340.2%.

In short, with proper plasticizer, temperature and shear, cornmeal could be used as a substitute material for starch-zein based thermoplastic. The incorporation of lignin and cellulose nanofibrils shows similar trend of improvement in cornmeal-based thermoplastic as well, which mean lignin and cellulose nanofibrils are both efficient reinforcement for corn-based thermoplastic.

### Example 4

### Water Resistance Improvement

Polyethylene oxide (PEO) was incorporated into the resin formulations to reduce the use of glycerol and increase water resistance of the products. PEO was incorporated into both starch/zein based formulations and cornmeal based formulations.

### Starch/Zein Based Formulations

Formulation (all units in parts):

| | | | Citric | | | |
|---|---|---|---|---|---|---|
| | Starch | Zein | acid | Glycerol | PEO | Peroxide |
| SZC | 88.89 | 20 | 0.5 | 35 | — | — |
| SZ-PEO15/G20 | 88.89 | 20 | 0.5 | 20 | 15 | 0.3 |

SZC: starch/zein control sample, no PEO was included.
SZ-PEO15/G20: 15 parts of glycerol was replaced by PEO; 0.5 parts peroxide was added.

### Preparation Procedure

Citric acid (CA) was dissolved in glycerol using a high-speed mixer, then, blended with PEO and stored in a glass bottle and sealed with flexible film for later use. Starch and zein were weighted and manually mixed in a beaker and then blended with the prepared PEO/glycerol/CA solution in a kitchen blender and then sealed in a plastic bag and stored overnight to achieve equilibrium. Peroxide was weighed and stored in a plastic bag separately and mixed with the prepared sample right before the extrusion to prevent the possibility of pre-reaction between peroxide and PEO.

The final mixture was extruded using a twin-screw extruder at a feeding rate of 4% and a screw speed of 100 rpm. Along the extruder barrel from Zone 2 to Zone10, the temperature was set at 90, 120, and 140° C. (Zone 4 to Zone 10) initially. Higher temperatures (150° C. and 160° C.) on Zone 4-Zone 10 were also tried to decrease the screw torque. At 140° C., the torque was around 100 Nm, which is near the upper limit of the extruder. The torque was decreased to 90˜95 Nm at 150° C. and 75 Nm at 160° C. The samples used for testing were eventually extruded at 160° C. It is worth noting that even with the 160° C. set temperature, the temperature of Zone 9 reached 185˜188° C. due to intensive shearing and mixing of the material inside the barrel.

### Tensile Testing Results

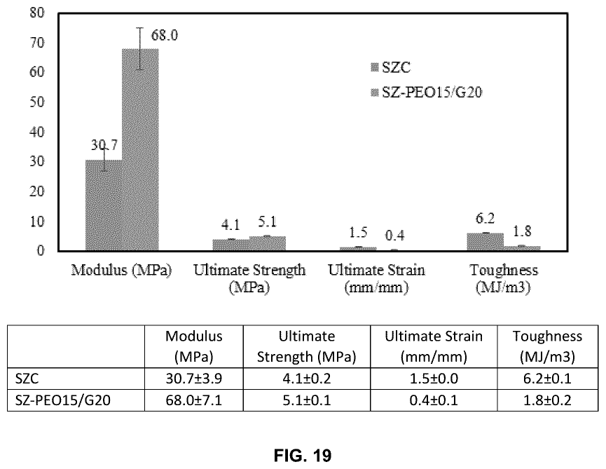

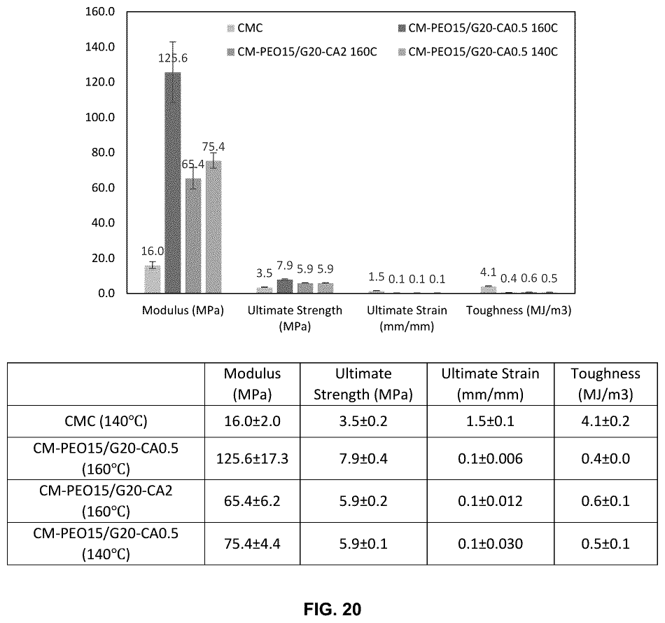

The results in FIG. 19 show that the strength and modulus of the samples are both increased after 15 parts of glycerol is replaced by PEO. Toughness of the samples is reduced as the sample becomes more rigid.

### Water Resistance

The samples were completely dried in a vacuum oven before they were put in a humidity-controlled desiccator (RH 56% and 79%). The weight gain of the samples is the moisture absorbance of the samples, which indicates their moisture/water resistance. Table 1 shows moisture absorption rate at two different relative humidity (RH) conditions. SZ-PEO15/G20 has lower absorbance at both RH than SZC, suggesting its higher moisture resistance.

TABLE 15

| | 56% RH | 79% RH |
|---|---|---|
| SZC | 11.9% | 20.4% |
| SZ-PEO15/G20 | 6.7% | 18.0% |

### Cornmeal Based Formulations

Formulation (Unit in Parts) and Sample Preparation:

| | | Citric | | | |
|---|---|---|---|---|---|
| | Cornmeal | acid | Glycerol | PEO | Peroxide |
| CMC | 108.89 | 0.5 | 35 | — | — |
| CM-PEO15/G20- | 108.89 | 0.5 | 20 | 15 | 0.3 |
| CA0.5 (160° C.) | | | | | |
| CM-PEO15/G20-CA2 | 108.89 | 2 | 20 | 15 | 0.3 |
| (160° C.) | | | | | |
| CM-PEO15/G20- | 108.89 | 0.5 | 20 | 15 | 0.3 |
| CA0.5 (140° C.) | | | | | |

The cornmeal-based formulations were prepared using the same procedure. Two CA loading levels (0.5 and 2) and two temperatures (140° C. and 160° C. for Zone 4-10) were used. Extruder screw speed was 60 rpm.

### Tensile Properties

Similar to the starch/zein based formulations, all the samples having 15 parts of PEG show much higher tensile strength and modulus, but lower toughness, than the control sample CMC. CM-PEO15/G20-CA0.5 (160° C.) exhibits the highest strength and modulus, followed by CM-PEO15/G20-CA0.5 (140° C.). CM-PEO15/G20-CA2 (160° C.) shows the lowest strength and modulus but the highest toughness. The results demonstrates that a high content of CA can lead to weakening of the samples, likely due to CA's reaction with the starch in the cornmeal, which results in degradation of the starch. It is also worth noting that under the same formulations, cornmeal based samples show comparable or even higher strength and modulus than starch/zein based samples. This is favorable to the industry because cornmeal has a much lower cost than starch/zein.

### Water Resistance

Table 16 shows the moisture absorption rate of the samples at 61% and 76% RH conditions. Compared to the CMC control, all the samples containing PEO show reduced moisture absorbance, especially at 76% RH.

TABLE 16

| | 61% RH | 76% RH |
|---|---|---|
| CMC (140° C.) | 12.4% | 22.1% |
| CM-PEO15/G20-CA0.5 (160° C.) | 7.8% | 14.4% |
| CM-PEO15/G20-CA2 (160° C.) | 8.7% | 14.3% |
| CM-PEO15/G20-CA0.5 (140° C.) | 8.1% | 14.4% |

In summary, incorporating PEO into the resin formulations (either starch/zein or cornmeal based) can substantially increase the samples' mechanical properties and moisture resistance.

The above specification provides a description of the manufacture and use of the disclosed compositions and methods. Since many embodiments can be made without departing from the spirit and scope of the invention, the invention resides in the claims.

What is claimed is:

1. A corn-based thermoplastic composition comprising:
from about 40 wt. % to about 80 wt. % of a corn-derived material comprising starch and zein;
from about 0.1 wt. % to about 20 wt. % of a reinforcement material comprising cellulose nanofibrils, lignin, or a combination thereof; and
from about 1 wt. % to about 50 wt. % of a plasticizer.

2. The composition of claim 1, wherein the corn-derived material comprises cornmeal.

3. The composition of claim 1, wherein the starch and zein are present in a ratio of about 1:1 to about 8:1.

4. The composition of claim 1, wherein the reinforcement material comprises the combination of cellulose nanofibrils and lignin.

5. The composition of claim 4, wherein the reinforcement material is present in an amount from about 1 wt. % to about 10 wt. %.

6. The composition of claim 1, wherein the plasticizer comprises glycerol, ethylene glycol, or polyethylene oxide.

7. The composition of claim 6, wherein the plasticizer is present in an amount from about 15 wt. % to about 35 wt. %.

8. The composition of claim 1, further comprising a processing aid in an amount from about 0.01 wt. % to about 10 wt. %.

9. The composition of claim 8, wherein the processing aid comprises an organic acid, optionally wherein the organic acid is citric acid.

10. The composition of claim 1, further comprising a thermal initiator, optionally wherein the thermal initiator comprises a peroxide.

11. A solid article formed from the composition of claim 1.

12. The article of claim 11, wherein the modulus of the article is at least about 50 MPa.

13. The article of claim 11, wherein the modulus of the article is increased by at least about 100% relative to a control article formed from a composition without the reinforcement material.

14. The article of claim 11, wherein the article is formed by injection molding, extrusion molding, or 3D printing.

15. A method of preparing a corn-based thermoplastic article, the method comprising:
combining a corn-derived material comprising starch and zein; a reinforcement material comprising cellulose nanofibrils, lignin, or a combination thereof; and a plasticizer to form a mixture,
wherein the corn-derived material is present in an amount from about 40 wt. % to about 80 wt. %;
wherein the reinforcement material is present in an amount from about 0.1 wt. % to about 20 wt. %; and
wherein the plasticizer is present in an amount from about 1 wt. % to about 50 wt. %; and
forming the mixture into the thermoplastic article.

16. The method of claim 15, wherein the corn-derived material comprises cornmeal.

17. The method of claim 15, wherein the starch and zein are present in a ratio of about 1:1 to about 8:1.

18. The method of claim 15, wherein the reinforcement material comprises the combination of cellulose nanofibrils and lignin.

19. The method of 15, wherein the plasticizer comprises glycerol, ethylene glycol, or polyethylene oxide.

20. The method of claim 15, further comprising a processing aid; wherein the processing aid is present in an amount from about 0.01 wt. % to about 5 wt. %.
